(19) United States
(12) Patent Application Publication
(10) Pub. No.: US 2024/0276918 A1
(43) Pub. Date: Aug. 22, 2024

(54) MACHINE AND METHOD FOR PROCESSING FIBRE PLANTS

(71) Applicant: HYLER BV, Sint-Baafs-Vijve (BE)

(72) Inventor: Niels BAERT, Sint-Baafs-Vijve (BE)

(21) Appl. No.: 18/580,951

(22) PCT Filed: Jul. 18, 2022
(86) PCT No.: PCT/IB2022/056596

§ 371 Date: Jan. 19, 2024

(30) Foreign Application Priority Data
Jul. 19, 2021 (BE) 2021/5566

(51) Int. Cl. A01D 45/06; A01D 47/00; A01D 57/20; A01D 69/03; G06T 7/60

(52) U.S. Cl. CPC A01D 45/065; A01D 47/00; A01D 57/20; A01D 69/03; G06T 7/60; G06T 2207/30188; G06T 2207/30252

(57) ABSTRACT

Described is a processing machine for processing relatively short fibre plants such as flax and relatively long fibre plants such as hemp. The processing machine comprises a self-propelling vehicle comprising a vehicle chassis provided with a first conveyor for transporting at least parts of the fibre plants from a first end to an opposite second end, and a second conveyor for transporting at least parts of the fibre plants from the first end to the second end, first and second delivering units provided at or close to the second end for the purpose of delivering and placing on the ground surface the fibre plants coming from respectively the first and second conveyor, and wherein the vehicle chassis comprises first mounting means for mounting of, as desired, either a first exchangeable picking unit or a second exchangeable picking unit.

The present invention relates to a machine and method for processing relatively long fibre plants, such as hemp.

Processing machines are known for picking such relatively long fibre plants (relative to short fibre plants, such as flax) and then placing the picked fibre plants on the ground surface in a number of mutually adjacent swathes. None of the known processing machines are however suitable for processing the long fibre plants in suitable manner, so that straight swathes of suitable dimensions result, when the heights thereof vary greatly over the field. None of the known processing machines are further suitable for taking into consideration in the picking and further processing of the long fibre plants that determined portions of the fibre plants, for instance the top portion or the Cannabidiol (CBD) portion of the fibre plants, must have a predetermined minimum length. This latter is difficult to realize when lengths of the fibre plants vary greatly, particularly when it must take place during travel.

It is an object of the invention to obtain an improved processing machine and an improved method for processing such long fibre plants.

It is also an object of the invention to provide a processing machine wherein the varying lengths of the fibre plants to be picked can be taken into consideration during travel.

According to a first aspect, at least one of these objects is achieved in a processing machine for processing relatively long fibre plants, such as hemp, the processing machine comprising:
a self-propelling vehicle, comprising a vehicle chassis with arranged thereon at least three wheels and a drive motor for driving at least two, preferably all, wheels, wherein the vehicle chassis is provided with:
   a first conveyor for transporting at least parts of the fibre plants from a first end to an opposite second end, and a second conveyor for transporting at least parts of the fibre plants from the first end to the second end;
   first and second delivering units provided at or close to the second end for the purpose of delivering and placing on the ground surface the fibre plants coming from respectively the first and second conveyor;
   a picking unit configured to pick the relatively long fibre plants and process them further, wherein the picking unit for picking the relatively long fibre plants comprises a lower picking element and an upper picking element for picking respectively a lower part of the fibre plants and an upper part of the fibre plants, wherein the upper picking element is embodied for pivoting relative to the lower picking element;
a displaceable top cutting unit configured to cut top parts off the fibre plants at a suitable length;
one or more lifting units for pivoting the lower and upper picking element relative to each other and relative to the vehicle chassis;
an electronic control unit configured to determine a height value representative of the height of the fibre plants;
wherein the control unit is further configured to determine on the basis of the determined height value of the fibre plants the desired positions of the pivotable lower picking element and the pivotable upper picking element.

According to an embodiment, the control unit is configured both to control the one or more lifting units of the lower picking element and to control the one or more lifting units of the upper picking elements for the purpose of pivoting the lower picking element and the upper picking element to the respective determined desired positions independently of each other.

According to an embodiment, the control unit is configured to determine on the basis of the determined height value of the fibre plants the desired position of the top cutting unit and to control at least one actuator whereby the top cutting unit is displaceable to the determined desired position relative to a lower and/or upper picking element, wherein the actuator is preferably configured to displace the top cutting unit to the determined desired position independently of the displacement of the lower picking element and the upper picking element.

According to an embodiment, the processing machine comprises at least one of a displaceable root cutting unit for cutting roots off the fibre plants at a suitable length and a displaceable fibre plant cutting unit for cutting the fibre plants, wherein the control unit is configured to determine on the basis of the determined height value of the fibre plants the desired positions of the displaceable root cutting unit and the displaceable fibre plant cutting unit.

According to an embodiment, the control unit is configured to control on the basis of the determined desired positions a first actuator of the top cutting unit, a second actuator of the root cutting unit, and a third actuator of the cutting unit for cutting the fibre plants for the purpose of displacing respectively the top cutting unit, the root cutting unit and the cutting unit to the desired positions, wherein the control unit is preferably embodied to displace respectively the top cutting unit, the root cutting unit and the cutting unit to the desired positions independently of each other and preferably independently of the displacement of the first and second picking unit.

According to an embodiment, the processing machine comprises an input unit, such as a keyboard, coupled to the electronic control unit and configured to allow manual input of the height value and to transmit the input height value to the electronic control unit.

According to an embodiment, the processing machine further comprises a camera unit with at least one camera, wherein the camera unit is configured to record images of the fibre plants to be processed and to generate an image signal which is representative of the recorded images, wherein the electronic control unit is coupled to the camera unit and the camera unit is configured to determine the height value of the fibre plants on the basis of the image signal.

According to an embodiment, the control unit is configured to control on the basis of the determined desired positions at least one of a first actuator of the top cutting unit, a second actuator of the root cutting unit, a third actuator of the cutting unit for cutting the fibre plants, and one or more lifting units for making the first picking element and the second picking element pivot.

According to an embodiment, the processing machine comprises a first and a second lifting unit for individually pivoting respectively the lower and upper picking element.

According to an embodiment, the second lifting unit is arranged between the lower and upper picking element and embodied to pivot the upper picking element relative to the lower picking element. According to an embodiment, the upper pivotable picking element is arranged pivotally on the first pivotable picking element. According to an embodiment, both the upper and the lower picking element are couplable to the vehicle chassis via hinges. According to an embodiment, the processing unit comprises a cutting unit configured to cut the fibre plants in the lower part and upper part, wherein the cutting unit is preferably mounted on the upper picking element. The cutting unit is preferably arranged via a displaceable support on the upper picking element, wherein the displaceable support preferably comprises an actuator coupled to the control unit for having the control unit adjust the height of the cutting unit relative to the rest of the picking element.

According to an embodiment, the processing machine comprises a transport installation for gripping fibre plants and transporting them to the first and second conveyors of the vehicle. This transport installation can be configured to turn the fibre plants during transport and/or the transport installation of the first and second picking unit can be configured to turn the fibre plants from a substantially upright position to a substantially lying position and/or the transport installation of the pick-up unit can be configured to turn the fibre plants from a substantially lying position to an overturned, substantially lying position.

According to an embodiment, a transport installation is arranged on at least one of the first picking unit, second picking unit and the pick-up unit and/or the transport installation comprises at least one pair of endless conveyor belts. These can be configured to grip the fibre plants therebetween and to transport them in gripped state, wherein the drive of the conveyor belts comprises one or more rollers driven directly via one or more hydraulic motors and/or wherein each of the picking units, particularly each of the picking elements of a picking unit, and/or the pick-up unit has its own transport installation, wherein the first picking unit preferably comprises four pairs of endless conveyor belts for gripping and transporting the fibre plants at four laterally mutually adjacent positions and/or wherein both the upper and the lower picking element comprise two pairs of endless conveyor belts for gripping and transporting fibre plants in each case at two positions for each of the two heights.

According to determined embodiments, the upper picking element comprises an upper transport installation for gripping and transporting the upper part of the fibre plant to the first conveyor of the vehicle and the lower picking element comprises a lower transport installation for gripping and transporting the upper part of the fibre plant to the second conveyor of the vehicle.

According to an embodiment, at least one of the root cutting unit and top cutting unit is preferably arranged on the picking unit frame for lateral displacement. The root cutting unit and/or top cutting unit can be provided with at least one actuator for setting the lateral cutting position of parts of the fibre plants to be transported to respectively the first and second conveyor on the vehicle by displacing the relevant cutting unit in lateral direction.

According to an embodiment, the control unit is configured to periodically repeat the calculation of the height of the fibre plants and the determination of the desired position, and to periodically control at least one of the picking elements, the top cutting unit, the root cutting unit and/or the cutting unit, preferably during travel of the vehicle.

According to an embodiment, the processing machine comprises a collecting element for collecting and storing therein cut-off parts of picked fibre plants, particularly root parts and/or top parts of fibre plants such as hemp plants.

According to an embodiment, the processing machine comprises first discharge means for discharging the cut-off top parts from the top cutting unit to a collecting element on the self-propelling vehicle, wherein the first discharge means preferably comprise a discharge conduit and a suction pump, particularly a centrifugal fan, for collecting and displacing cut-off top parts and/or second discharge means for discharging the cut-off root parts from the root cutting unit to the ground surface, wherein the second discharge means are preferably configured for depositing on the ground in front of one or more wheels of the vehicle in axial direction.

According to a second aspect, at least one of these objects is achieved in a method for processing relatively long fibre plants such as hemp, the method comprising of:
driving the processing machine over the ground surface and picking the relatively long fibre plants while driving the processing installation, and then processing the fibre plants and thereafter placing the processed fibre plants back onto the ground, the method further comprising of:
determining a height value representative of the height of the fibre plants to be picked by means of an electronic control unit;
determining on the basis of the determined height value of the fibre plants the desired positions of the pivotable lower picking element and the pivotable upper picking element, preferably also of the displaceable top cutting unit.

The method preferably comprises both of controlling the one or more lifting units of the lower picking element and of controlling the one or more lifting units of the upper picking elements for the purpose of pivoting the lower picking element and the upper picking element to the respective determined desired positions independently of each other.

The method preferably comprises of determining on the basis of the determined height value of the fibre plants the desired position of the top cutting unit and of controlling at least one actuator whereby the top cutting unit is displaceable to the determined desired position relative to a lower and/or upper picking element, preferably also comprises of displacing the top cutting unit to the determined desired position independently of the displacement of the lower picking element and the upper picking element.

The method preferably comprises of determining on the basis of the determined height value of the fibre plants the desired positions of at least one of the displaceable top cutting unit, a displaceable root cutting unit for cutting roots off the fibre plants at a suitable length, and a displaceable fibre plant cutting unit for cutting the fibre plants, and of displacing them to the determined desired positions, preferably independently of each other and preferably independently of the displacement of the first and second picking unit.

The method preferably comprises of controlling on the basis of the determined desired positions at least one of a first actuator of the top cutting unit, a second actuator of the root cutting unit, a third actuator of the cutting unit for cutting the fibre plants.

The method preferably comprises of receiving the height value by means of the electronic control unit via an input unit, such as a keyboard, coupled thereto.

The method preferably comprises of:
recording images of the fibre plants to be processed with a camera unit with at least one camera and generating an image signal which is representative of the recorded images;
determining on the basis of the image signal the height value of the fibre plants by means of the electronic control unit coupled to the camera unit.

The method preferably comprises of individually pivoting respectively the lower and upper picking element for the purpose of achieving the positions desired for the lower and upper picking element.

The method preferably comprises of:
gripping upper parts of the fibre plants with the upper picking element;
cutting the gripped upper parts of the fibre plants loose with the cutting unit;
transporting the upper parts of the fibre plants which have been cut loose to the first conveyor of the vehicle;
gripping lower parts of the fibre plants with the lower picking element;
transporting the gripped lower parts of the fibre plants to the second conveyor of the vehicle;
transporting the upper and lower parts of the fibre plants on respectively the first and second conveyor;
placing the upper parts of the fibre plants on the ground in a first row with the first delivering unit; and
placing the lower parts of the fibre plants on the ground in a second row, parallel to the first row, with the second delivering unit.

The method preferably comprises of pivoting the first picking element and/or the second picking element relative to the vehicle, preferably also of pivoting the cutting unit relative to the second picking element, for the purpose of setting the length (lₒ) of the lower parts and the length (l_{b}) of the upper parts of the fibre plants, on the basis of the desired positions determined by the control unit, and optionally of cutting the top parts off the upper parts which have been cut loose and/or the root parts off the lower parts of the fibre plants at the desired position(s).

The method preferably comprises of periodically repeating the determination of a height value which is representative of the height of the fibre plants which are about to be processed.

The method preferably comprises of, during travel, periodically repeating the determination on the basis of an image signal of the height value of those fibre plants which are about to be processed.

The invention will be further elucidated below on the basis of various embodiments.

The picking elements of the picking unit are pivotable relative to the vehicle chassis and/or relative to each other. At least one lifting unit is provided whereby at least one of the upper and lower picking element can be pivoted upward or downward as desired.

The lifting unit of the vehicle can be configured to individually set the height of the lower picking element and the upper picking element relative to the vehicle, optionally during travel, and can thereby be adapted relative to the ground surface and relative to the top portion of the fibre plants.

The picking unit for picking the relatively long fibre plants comprises a lower picking element and an upper picking element which are configured to pick respectively a lower part of the fibre plants and an upper part of the fibre plants. Different parts of the fibre plants can therefore be processed (for instance harvested) simultaneously, this resulting in a great processing capacity of the processing machine.

In determined embodiments a cutting unit is provided, also referred to here as a mowing unit, which is configured to cut the fibre plants for the purpose of thereby dividing the fibre plants into a lower part and upper part. In this way the long fibre elements can be processed better and more efficiently, and it is also possible to place the fibre plants down on the ground in two (or more) rows in order to allow retting thereof on the land. It is advantageous here to mount the cutting unit on the upper picking element. In determined embodiments the cutting unit is constructed from a (horizontal) row of mutually reciprocally displaceable blades in which a large amount of fibre plants can be cut, this row extending over a substantial or substantially whole width of the upper picking element. The reciprocal displacement of the blades of such a cutting unit is driven by a motor, for instance an electric motor. The cutting unit is further preferably mounted on the upper picking element such that the height of the cutting unit relative to the rest of the picking element and thereby the height of the cutting unit relative to the ground surface can be adjusted as desired (for instance depending on plant length).

The cutting unit can be arranged via a displaceable support on the upper picking element. The displaceable support can here comprise a remotely controllable actuator for remotely adjusting the height of the cutting unit relative to the rest of the picking element. The axial cutting position of the cutting unit is here preferably situated in front of the axial position of the engaging point (also referred to here as the engaging position) of the lower picking element. The upper picking element can hereby engage the upper part of the fibre plants first while travelling, and the lower picking element will not engage the lower part of these same fibre plants until the upper part of the fibre plants has been cut loose from the lower part thereof.

In order to make fibre plants into two (or more) parts of suitable lengths the upper picking element is embodied for pivoting relative to the first picking element so that the pivot position of the second picking element relative to that of the first picking element can be set in simple manner.

The processing unit of the processing machine can comprise one or more own transport installations for gripping fibre plants and transporting the gripped fibre plants to the first and second conveyors of the vehicle. This makes the processing of the fibre plants in the sense of harvesting, picking up and optionally rotating the position of the fibre plants a task for the processing unit. This means that the vehicle itself need not in principle be modified when one processing unit is exchanged for another processing unit.

The transport installation can be configured to rotate the fibre plants during transport. When the pick-up unit is used, this rotating comprises for instance of wholly turning over picked-up fibre plants, which fibre plants are located flat on the ground surface after a previous processing step (i.e. after the fibre plants were picked on the front side of the relevant picking unit and placed back down onto the ground on the rear side of the vehicle at an earlier stage). When a picking unit is used, this rotating comprises for instance of rotating the fibre plants picked in substantially vertical position to a horizontal position, in which latter position they can for instance be easily moved on to the delivering unit by a first or second conveyor on the self-propelling vehicle itself.

More particularly, in determined embodiments the transport installation(s) of the picking unit can be configured to turn the fibre plants from a substantially upright position to a substantially lying position.

Harvesting of the fibre plants can be brought about by a transport installation comprising at least one pair of endless conveyor belts which are configured to grip fibre plants therebetween and transport them in gripped state. This transport installation, more particularly the endless conveyor belts, are preferably driven by one or more rollers (these including drums, pulleys and so on), wherein each of the driven rollers is coupled to its own hydraulic motor for rotation thereof. Other means, such as mechanical transmissions and the like, can be dispensed with. The transport installation(s) of the processing unit can hereby take a relatively light and simple form, wherein there is also the option to drive the conveyor belts individually, for instance at different speeds, as far as desirable.

As described above, the harvested fibre plants can optionally also undergo cutting processes. The first picking unit and/or the second picking unit can comprise a root cutting unit configured to cut a root part off the rest of the fibre plant and/or a top cutting unit configured to cut the top part off the rest the fibre plant. At least one of the root cutting unit and top cutting unit is preferably arranged for lateral displacement on the frame of the picking unit and provided with at least one actuator, such as a lifting cylinder with lying orientation, for setting the lateral cutting position and thereby the length of the parts of the fibre plants to finally be transported to respectively the first and second conveyor on the vehicle by displacing the relevant cutting unit in lateral direction.

As set forth above, optionally provided are a camera unit with at least one camera, wherein the camera unit is configured to record images of the fibre plants to be processed and to generate an image signal which is representative of the recorded images, and an electronic control unit coupled to the camera unit for determining the height of the fibre plants on the basis of the image signal.

The electronic control unit determines for instance the (average) height of the fibre plants to be picked, i.e. the fibre plants situated directly in front of the picking unit, and expresses this in a height value. The determined height value can be used to set the picking unit as desired and to adjust the setting of for instance the height of the first and/or second picking element above the ground surface, the lateral position and/or height position of one or more of the cutting units relative to the rest of the picking unit or relative to the ground surface to the conditions. The driver can do this manually, for instance by adjusting the pivoting positions of the picking elements using the lifting units from the driver's cab by adjusting the height position of the root cutting unit and/or mowing unit, and/or by adjusting the lateral position of the top cutting unit. In other embodiments the above stated is however performed automatically. The electronic control unit which has calculated the average height of the fibre plants on the basis of the received image signal can determine on the basis of the calculated height and further of a number of requirements, for instance a minimum length of the top portions, maximum width of the swathes and the like, the desired positions of at least one of a top cutting unit for cutting top parts off the fibre plants, a root cutting unit for cutting roots off the fibre plants, an actuator, for instance a hydraulic cylinder, of a cutting unit for cutting the fibre plants, and at least one lifting unit for lifting or lowering an exchangeable picking unit, particularly a first and second lifting unit for individually pivoting a lower picking element and the upper picking element of the picking unit. In a determined embodiment these desired positions can be shown to the driver on a screen so that the driver can position the picking element(s) and cutting units at the correct positions. In a further embodiment the control unit is connected to at least one of the lifting units of the picking elements and actuators of the cutting units, and the control unit is configured to be controlled such that the desired positions are reached. The control unit can particularly be configured to control these units and/or actuators such that the resulting swathe lies centrally in the (transport belts of the) conveyors. It is also possible not to grip the swathe centrally but to grip it slightly lower at a determined ratio, for each of the two swathes.

This determining of the height of the fibre plants, determining of the desired positions of the picking elements/cutting units and controlling of the actuators/lifting units thereof can be performed just once, for instance just before picking of a field of fibre plants. In other embodiments the above is however repeated in each case, for instance while the vehicle travels over the field and picks the fibre plants, so that possible variations in the height of the fibre plants can be followed during travel. Continuous steering adjustments can particularly be made in the case of varying height.

Further advantages, features and details will be elucidated with reference to the following description of some embodiments, shown in the accompanying figures. The figures comprise:

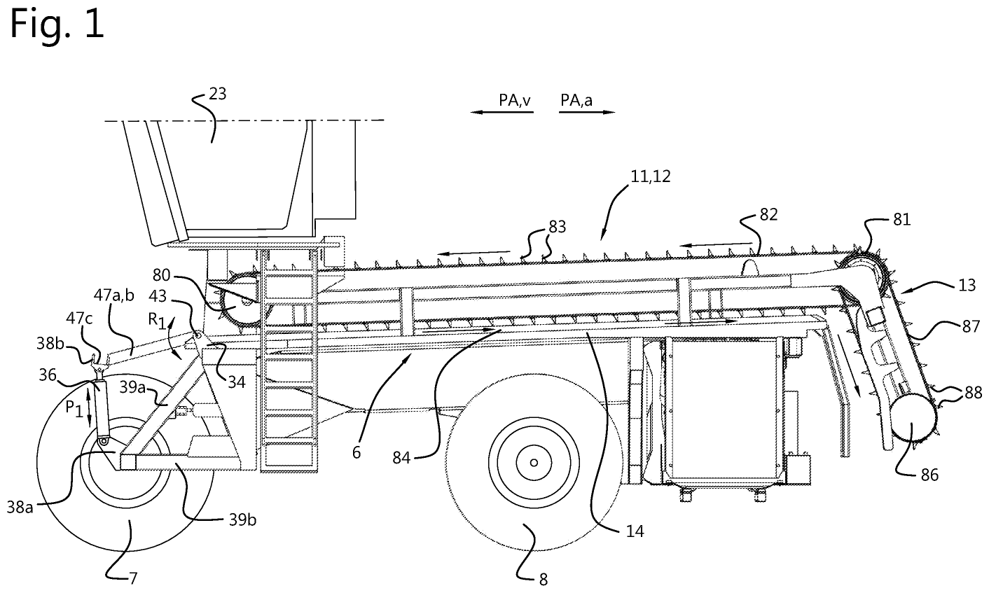

FIG. 1 is a partially cut-away side view of an embodiment of a vehicle according to the invention;

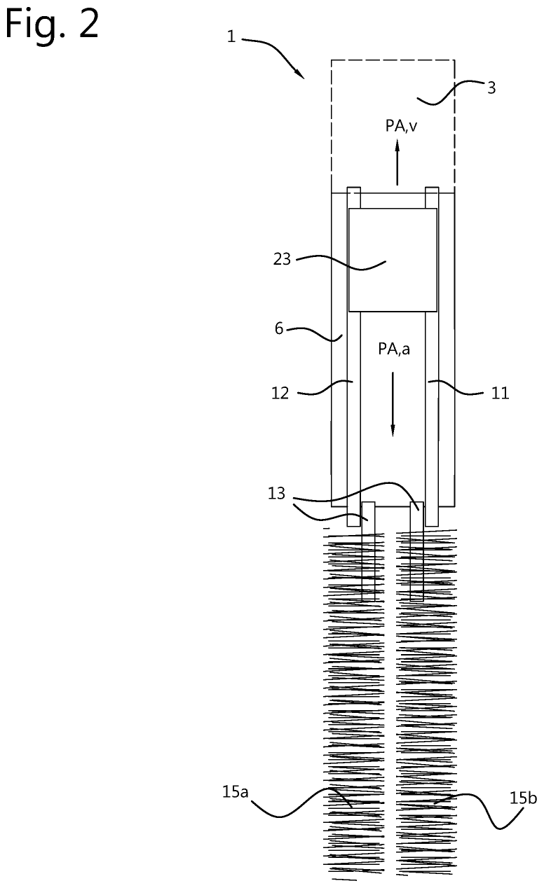

FIG. 2 is a schematic top view of the vehicle of FIG. 1, provided on the front side with a processing unit;

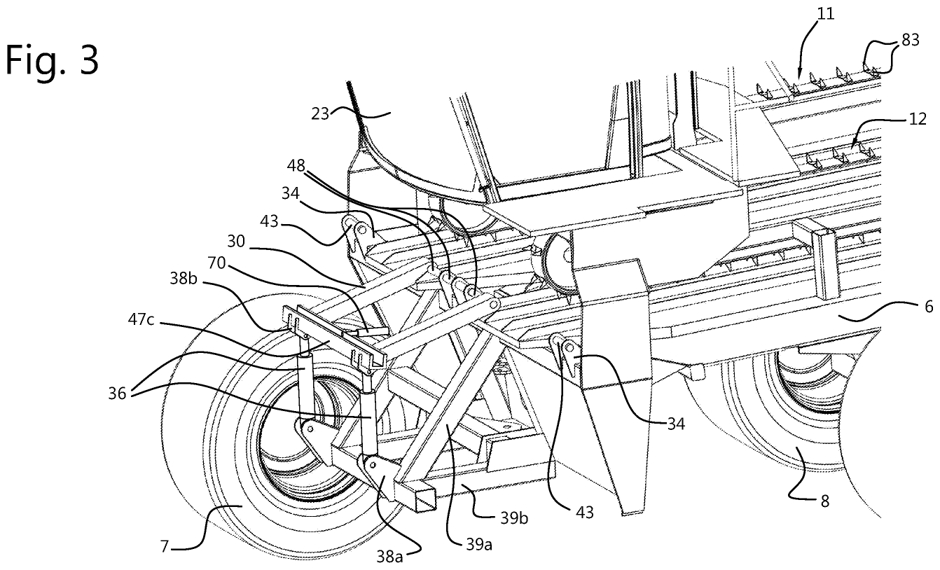

FIG. 3 is a partially cut-away perspective side view of the embodiment of the vehicle according to FIGS. 1 and 2;

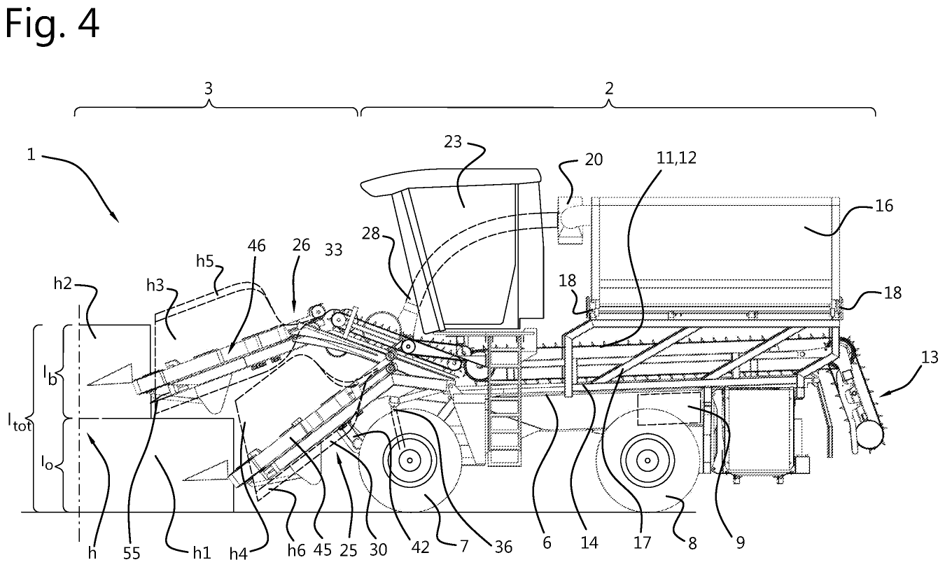

FIG. 4 is a side view of a processing machine according to an embodiment of the invention, wherein a processing unit 3 is mounted on vehicle 1 and is suitable for processing of long fibre plants;

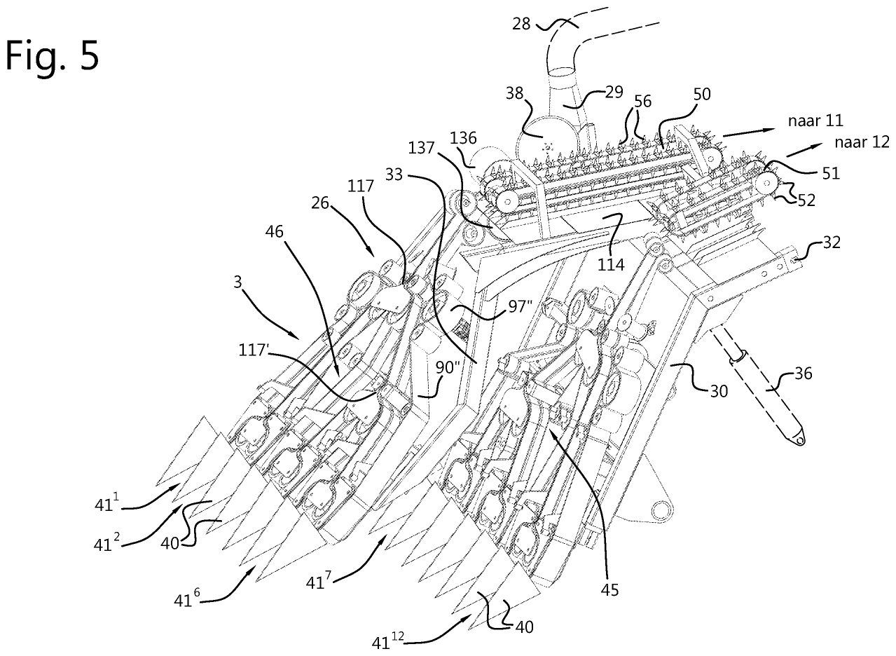

FIG. 5 is a detail view of an embodiment of a processing unit 3 according to the invention;

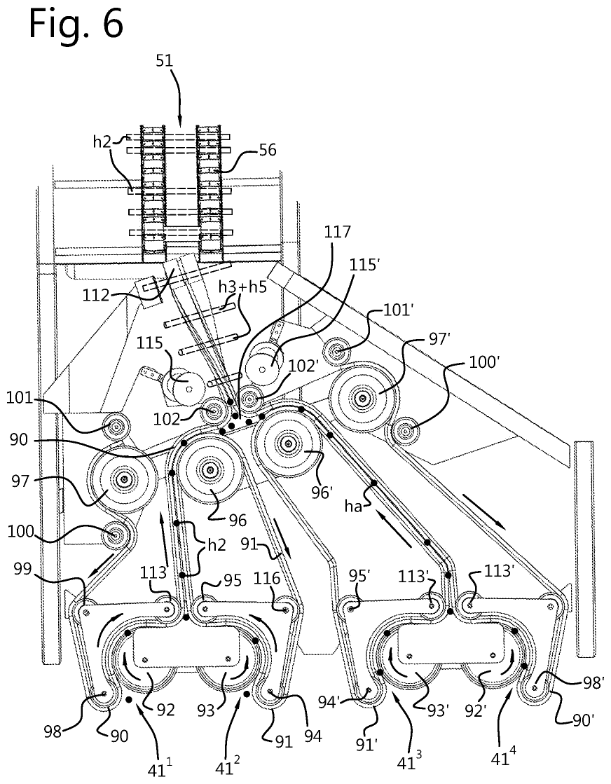

FIG. 6 is a top view of an alternative embodiment of a processing unit according to the invention;

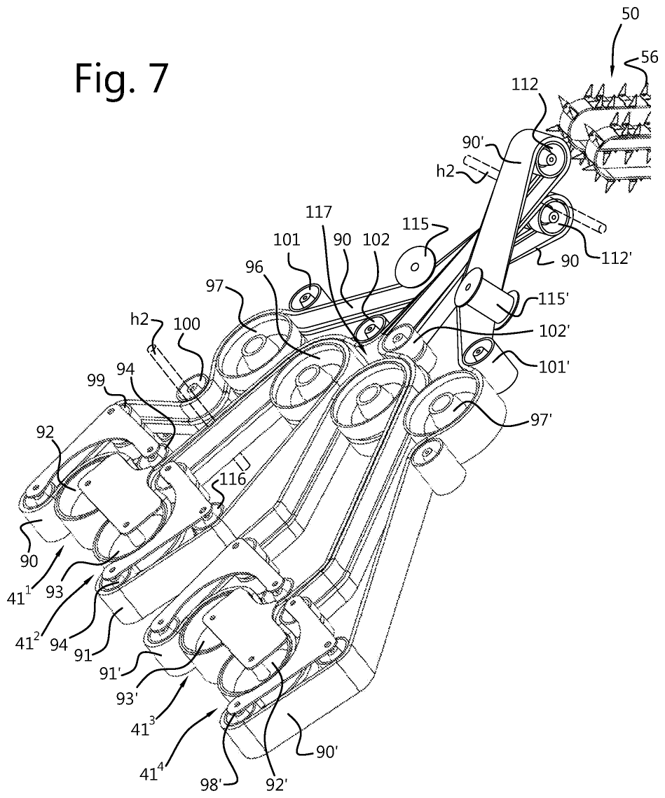

FIG. 7 is a perspective side view of the embodiment of FIG. 6;

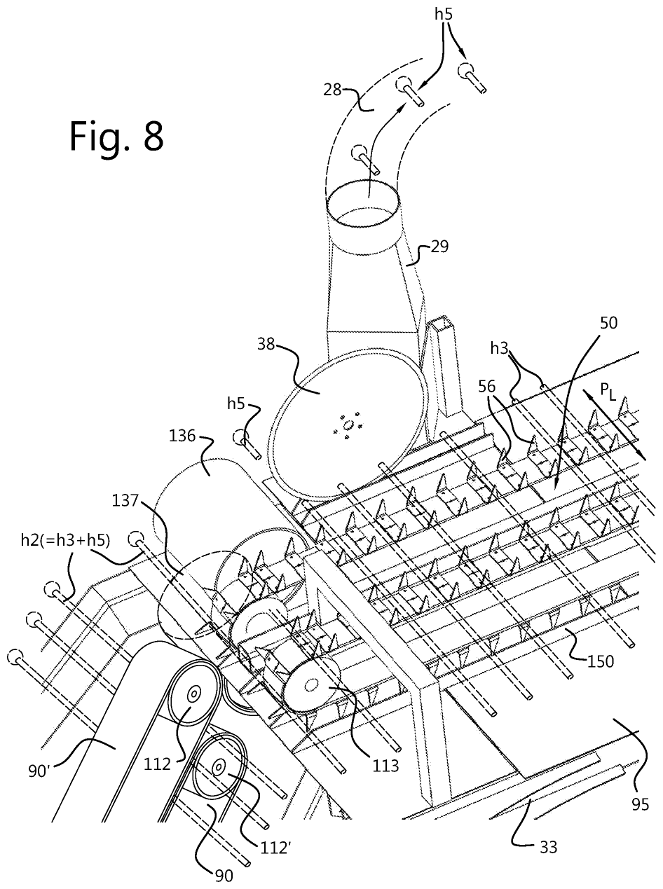

FIG. 8 is a perspective detail view of the embodiment of the processing unit according to FIGS. 5-8;

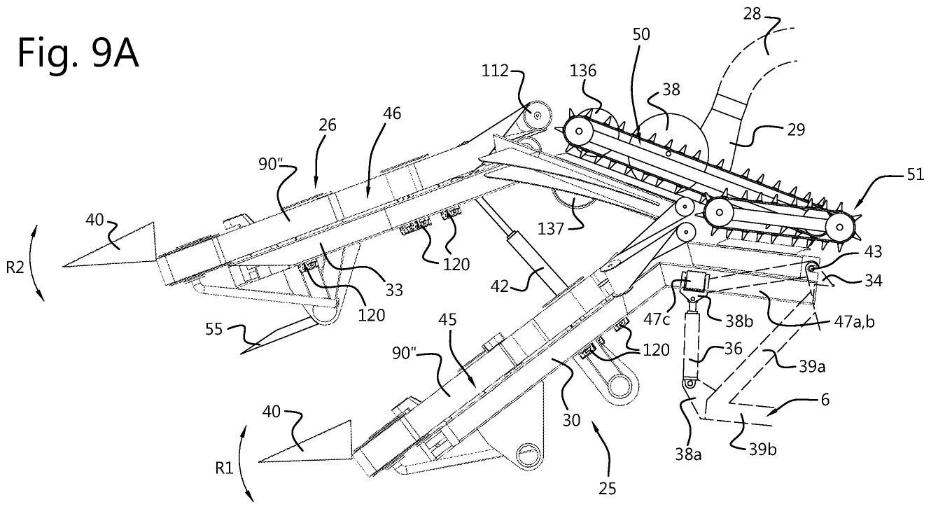

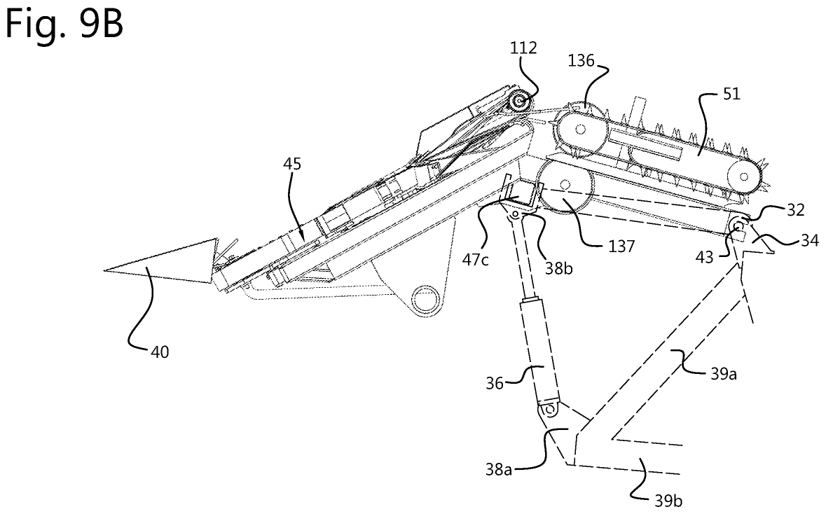

FIG. 9A is a side view of the embodiment of FIG. 5 with the lower processing element in a first pivot position;

FIG. 9B is a side view of a part of the embodiment of FIG. 5 with the lower processing element in a second pivot position;

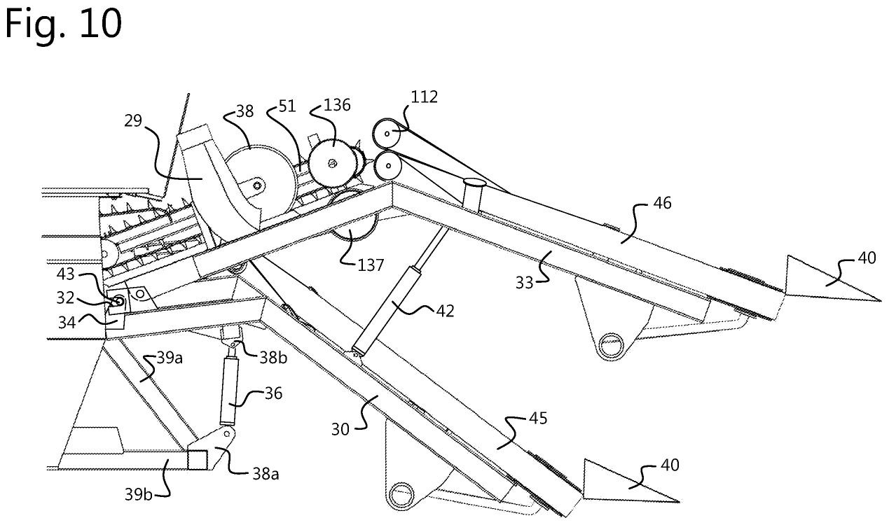

FIG. 10 is a further side view of the embodiment of FIG. 5;

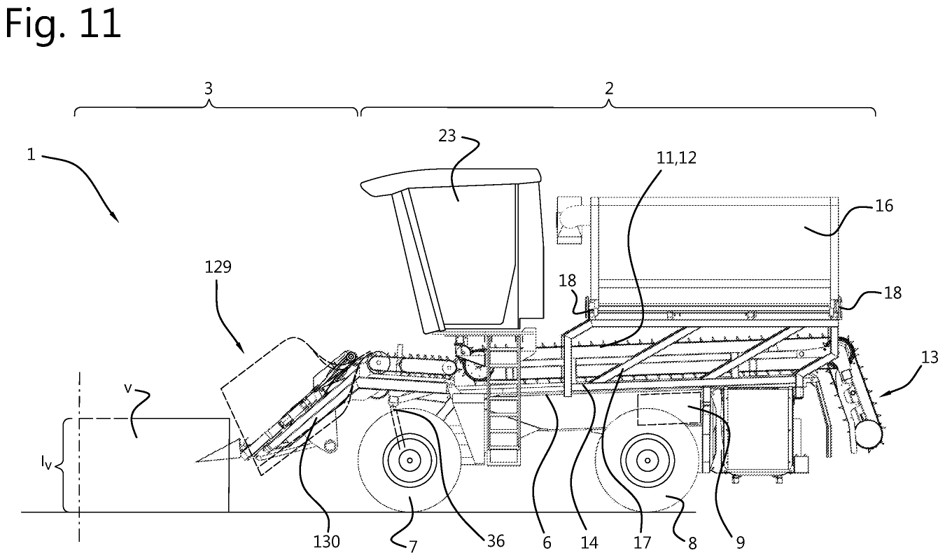

FIG. 11 is a side view of a processing machine according to an embodiment of the invention, wherein a processing unit 3 is mounted on vehicle 1 and is suitable for processing of short fibre plants;

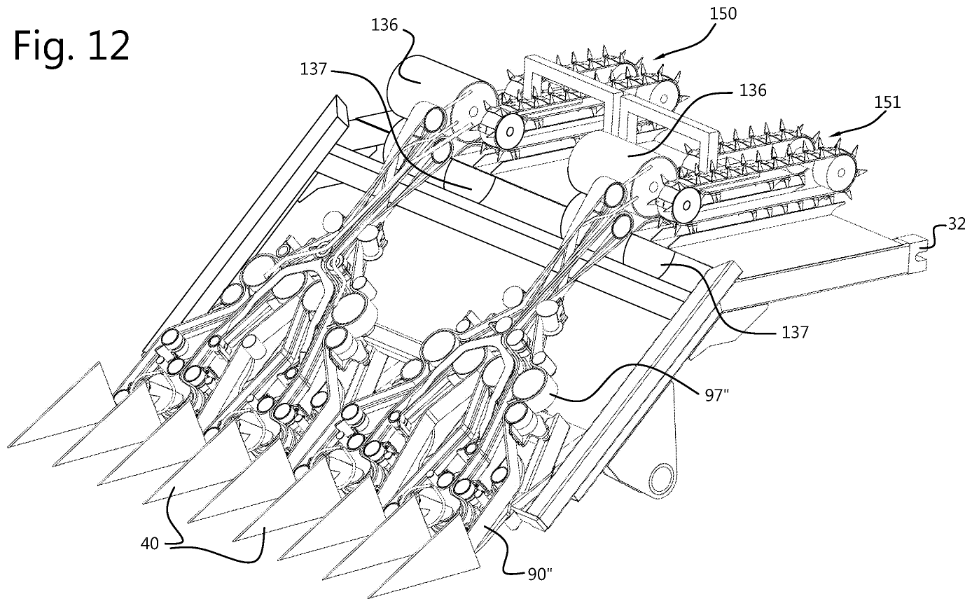

FIG. 12 is a detail view of the embodiment of FIG. 11;

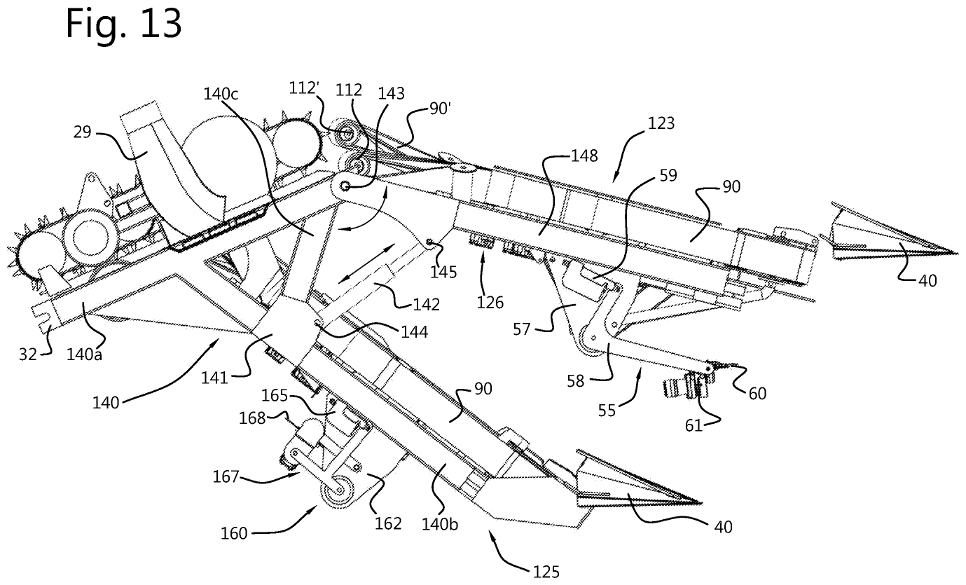

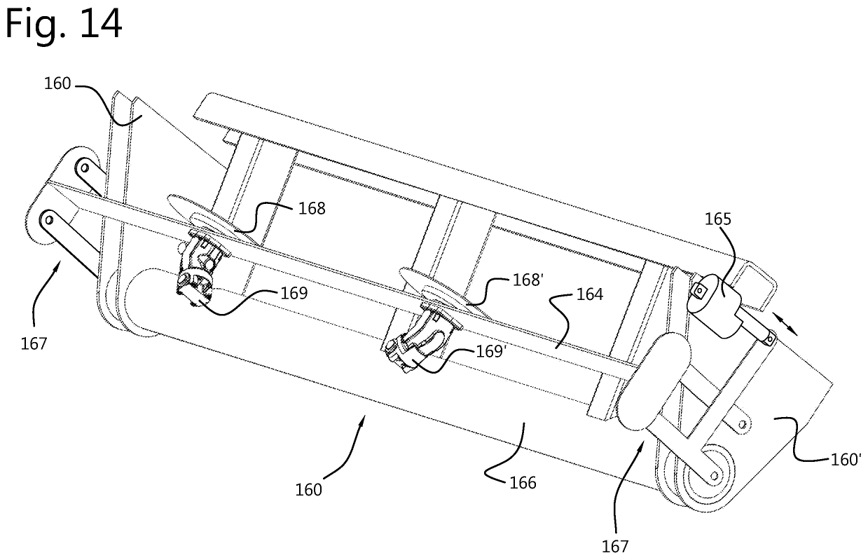

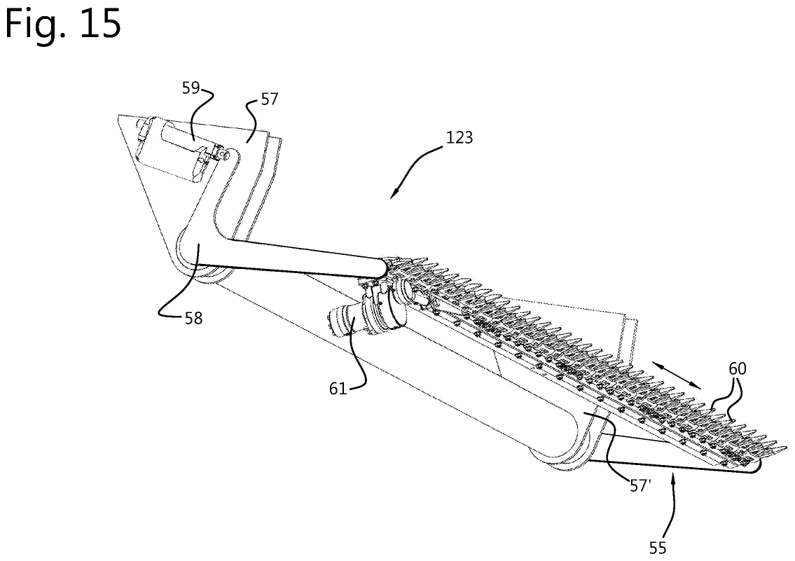

FIGS. 13-15 are views of a further embodiment of the processing machine according to the invention, wherein FIG. 13 is a side view of a further embodiment of a hemp picking unit with an alternative mounting of the picking elements on each other and on the vehicle chassis, FIG. 14 a detail view of the root cutting unit of FIG. 13, and FIG. 15 is a view of the cutting unit or mowing unit for cutting loose the upper parts of fibre plants from the lower parts thereof, as can be applied in all embodiments.

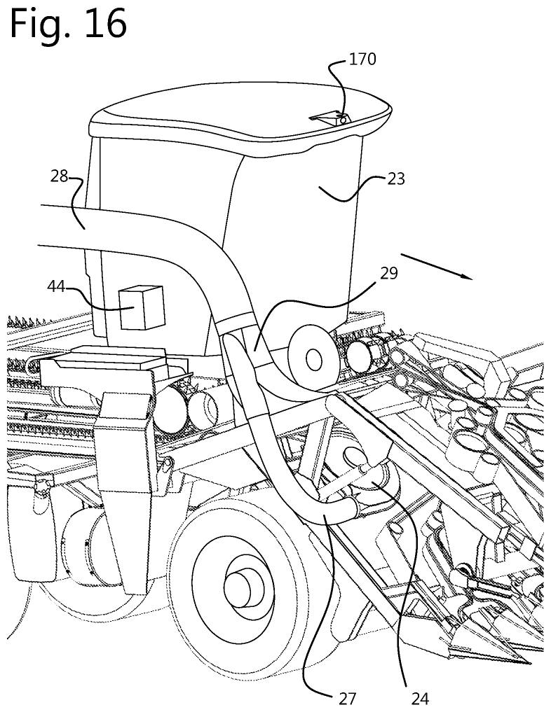

FIG. 16 is a view of a further embodiment of the processing machine;

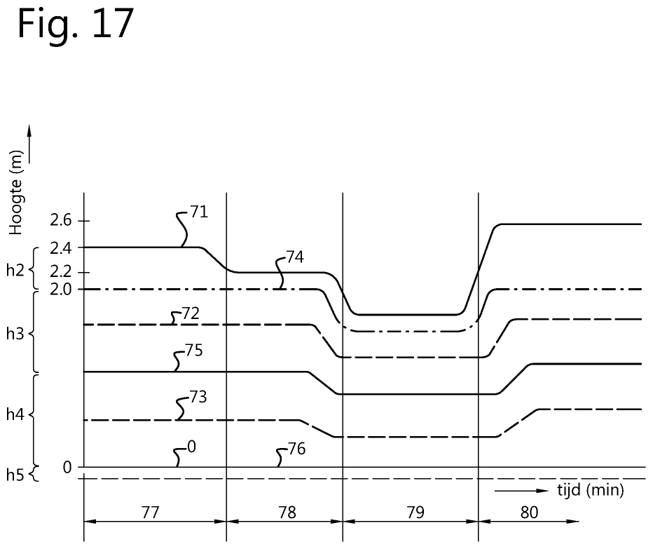

FIG. 17 is a diagram with an example of the control of the height position of the picking elements, the root cutting unit and the cutting (mowing) unit and the lateral position of the top cutting unit; and

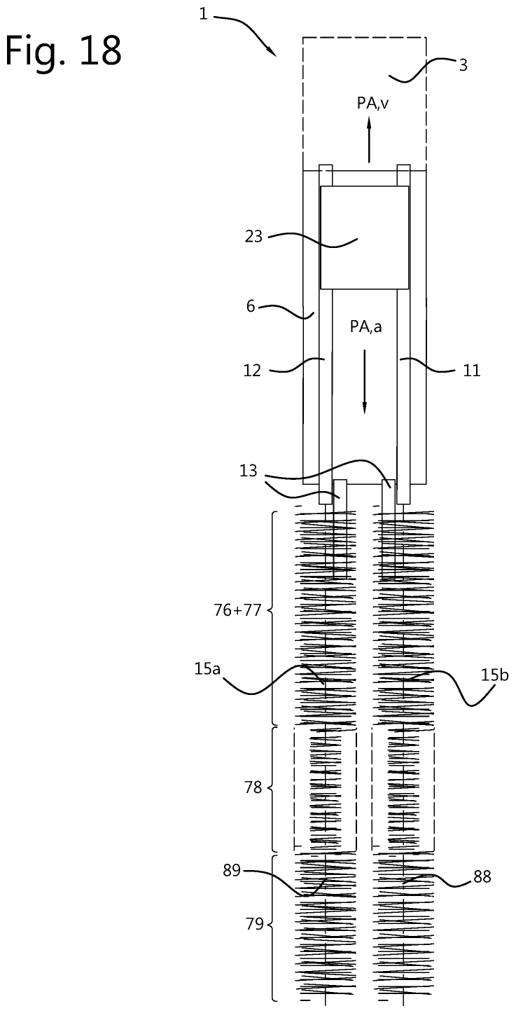

FIG. 18 is a schematic top view of the vehicle of FIG. 2, with the variations in height of fibre plants from the diagram of FIG. 17.

Flax is a fibre crop which is cultivated for making linen, among other things. The flax plant is usually between 80 and 120 cm long, and is harvested using a drawn or self-propelling flax picking machine. For this purpose the flax picking machine has on the front side a picking unit embodied specifically to pull the flax plants from the ground. The harvested flax plants are then processed by the flax picking machine by displacing them to the rear side of the flax picking machine and placing the flax plants on the ground surface during travel. The flax plants are placed flat on the ground in long rows, also referred to as “swathes”, wherein the stems of the harvested flax plants extend substantially transversely of the longitudinal direction of the swathes. This placing back of the flax flat onto the ground surface so that said swathes are created is also referred to as “depositing” or “picking up”. When the flax plants are placed in rows or swathes, an intermediate space is left between adjacent rows. These spaces are provided in order to prevent the swathes from becoming tangled in each other.

The harvested flax plants which were placed flat on the ground in swathes are then retted under the influence of a combination of dew, rain and sunlight. The retting of the flax by leaving the flax plants on the ground (i.e. a field or retting field) for some time is referred to in the field of processing flax as field retting or dew retting. In order to obtain a uniform retting and to prevent rotting of the flax, the flax placed flat on the ground in rows must be flipped over regularly. This flipping over of the flax placed flat on the ground is also referred to as “turning”. The turning of the flax is performed using a drawn or self-propelling flax turner.

Hemp is likewise a fibre crop which is cultivated for making textile fabrics or rope, among other things. The hemp plant is a lot longer than the flax plant. The hemp plant is characteristically between 140 cm and 240 cm in length. The hemp is usually cut at the base of the hemp plant and then processed further.

This would therefore already necessitate at least four different machines to enable optimal processing of both hemp and flax. This results in high purchase, use and maintenance costs. In embodiments of the present invention a processing machine is provided which is suitable in principle for harvesting/picking and/or turning relatively long fibre plants such as hemp or kenaf and relatively short fibre plants such as flax.

FIG. 1 shows a self-propelling vehicle 2 of a processing machine 1 according to a determined embodiment of the invention. Self-propelling vehicle 2 comprises a vehicle chassis 6 on which four wheels, i.e. two front wheels 7 and two rear wheels 8, are arranged in known manner. In FIG. 1 a part of the front left side of the vehicle has been cut away (i.e. the front left wheel and the relevant part of the wheel suspension) in order to obtain a better view of the construction of the vehicle on the front side. The vehicle is self-propelling, which means that it is provided with its own drive motor whereby a number of the wheels, for instance the two rear wheels, or all the wheels can be driven. The vehicle is steered from a driver's cab 23 on the front side of the vehicle. Chassis 6 comprises two parallel conveyors 11, 12 formed by a loading floor or platform 14 and two endless conveyor belts provided thereabove. At least one of the endless conveyor belts can here be adjusted in lateral direction so that the intermediate distance between the two conveyor belts can be adjusted, this in order to realize a suitable intermediate distance for shorter or longer swathes. Referring to the top view of FIG. 2, the two conveyors 11, 12 are arranged along both longitudinal edges of vehicle 2 so that a quantity of fibre plants can be transported in axial rearward direction (P_{A,a}) with each of these. In the shown embodiment each of the conveyors 11, 12 comprises an endless conveyor belt 82 which runs on a front roller 80 and a rear roller 81. At least one of the rollers 80, 81 is driven via a drive (not shown). In a determined embodiment the drive comprises a hydraulic motor arranged in the rear (triple) pulley or roller 81. Each of the respective part-rollers of the multiple (triple) pulley is driven separately yet synchronously to each other, preferably according to a determined ratio as desired. So-called carriers 83 are provided on the outer side of conveyor belt 82. These can displace the fibre plants lying on platform 14, at least on guide rails 84 of the platform (FIG. 1), in said axial rearward direction (P_{A,a}) to the rear side of chassis 6. The fibre plants are thus enclosed here between conveyor belt 82 and guide rails 84.

On the rear side of vehicle 2 a delivering unit 13 is arranged for each conveyor 11, 12. In the shown embodiment the delivering unit 13 comprises an endless belt conveyor 87. The endless belt of each of the endless belt conveyors 87 is trained around a roller 86 and around said roller 81 (a belt conveyor 87 therefore sharing this with a conveyor 11 or 12). Driving of delivering unit 13 takes place the first roller 81. This extends obliquely rearward to some extent and is configured to displace the fibre plants coming from respective conveyor 11, 12 downward in dosed and controlled manner so that the fibre plants can be placed on the ground on the rear side of the vehicle. As shown in FIG. 2, when the vehicle moves in an axial forward direction (P_{A,v}), the fibre plants (v) picked or picked up on the front side of the vehicle will be displaced to the rear side of vehicle 2 and will each be placed down on the ground (o) in a separate row 15a, 15b via delivering units 13. In determined applications the rows 15a, 15b of fibre plants are composed of the same parts of the fibre plant, for instance in the case of the relatively short flax plants. In other embodiments the one row is however composed of the lower portions of the harvested fibre plants, while the other row consists of the upper portions of the harvested fibre plants. This is for instance the case when hemp plants are harvested. In both cases the fibre plants are placed flat on the ground, parallel to each other as far as possible, after which said retting can commence.

Vehicle 2 is provided on its front side with an exchangeable processing unit 3 in order to be able to pick the fibre plants or to be able to pick fibre plants already placed flat on the ground at an earlier stage back up again. A picking unit is arranged on the front side in the case that the fibre plants are being picked, while a processing unit 3 will be a pick-up unit in cases where fibre plants which have already been picked and placed on the ground previously are being picked up. A different picking unit will further be mounted on the vehicle depending on the length of the crop to be picked.

Referring to FIGS. 1 and 3 in particular, vehicle 2 comprises on the front side of chassis 6 a number of support chassis parts 39a, 39b. The support chassis parts 39b extend in line with the rest of chassis 6 of vehicle 2, while the support parts 39a mounted on support parts 30b and the rest of chassis 6 are disposed obliquely. Chassis 6 is further provided with a number of hinges 48 on which two parallel longitudinal lifting arms 47a, 47b are arranged. Both longitudinal lifting arms 47a, 47b are connected at their outer ends to a transverse lifting arm 47c. The support chassis parts 39a, 39b, longitudinal lifting arms 47a, 47b and transverse lifting arm 47c together form a strong and stable support structure for mounting a number of actuators whereby a processing unit 3 coupled to the chassis 6 of vehicle 2 can be pivoted upward and downward. Together with these actuators the support structure forms the above stated lifting unit.

The pivoting of processing unit 3 is brought about by a number of actuators, for instance electric motors or, preferably, lifting cylinders 36, of the lifting unit. In FIGS. 1 and 3 the actuators are formed by two lifting cylinders 36. In the shown embodiment two lifting cylinders positioned laterally adjacently of each other are provided. In other embodiments use is however only made of a single lifting cylinder, or three or more lifting cylinders are applied. The lifting cylinders are mounted pivotally on the support chassis parts 39a, 39b via hinges 38 and on transverse lifting arm 47c via a mounting support 38b. A further description of the construction of the lifting unit and of the operation thereof will follow below.

Referring to FIG. 3, chassis 6 is provided on either side of the support chassis parts 39a, 39b with first mounting means 34 for mounting a processing unit 3 thereon in pivotable and releasable manner. The first mounting means 34 can be embodied in numerous ways, but in the shown specific embodiment comprise a number of flanges in which respective pivot shafts 43 can be rotatably mounted.

Each of the different processing units 3 comprises one or more frame parts, wherein at least one of these frame parts can be mounted in pivotable and releasable manner on said first mounting means 34. In the embodiments shown in FIGS. 4-9 the processing unit 3 comprises a first, lower hemp picking element 25 and a second, upper hemp picking element 26 placed thereabove. The lower hemp picking element comprises a frame part 30 which can be mounted pivotally and in easily releasable manner on first mounting means 34 of the vehicle using second mounting means 32. The upper hemp picking element 26 comprises a frame part 33 which is likewise arranged pivotally (and optionally releasably) on the first mounting means 34 of vehicle 2. The upper hemp picking element 26 can here be mounted directly on (the mounting means 34 of) vehicle 2. This can however also be performed in indirect manner. FIG. 13 for instance shows an embodiment wherein the lower frame part is arranged pivotally (and optionally also releasably) on the mounting means 34 of vehicle 2 and the upper frame part is arranged pivotally on the lower frame part. The upper frame part is thus mounted on (the mounting means of) vehicle 2 in indirect manner, via a part of the lower frame part. In still further embodiments it is conversely the upper frame part which is mounted directly on (the mounting means of) the vehicle 2, wherein the lower frame is mounted pivotally on the upper frame part. It is important that both frame parts are essentially pivotable independently of each other in height direction relative to vehicle 2 in order to thus be able to set the height of the gripping of the crop by the upper and lower picking unit as desired. This setting of the heights can take place beforehand, for instance before a field of hemp plants is picked, but can also be performed during the picking (i.e. on the fly), for instance in continuous or intermittent manner, wherein in determined embodiments the (absolute or relative) height positions of the different cutting and mowing units can also be set. This aspect of the invention will be elucidated below.

As already described above, in determined embodiments shown in the figures the frame part 33 of the upper hemp picking element 26 can be mounted on the frame part 30 of the lower hemp picking element 25 instead of directly on the chassis 6 of the vehicle. In other embodiments (not shown) it is however precisely the upper hemp picking element that is mounted on chassis 6 of vehicle 2, and the lower hemp picking element on the upper hemp picking element. In still further embodiments (not shown) the two hemp picking elements are mounted pivotally and releasably on vehicle 2.

For mounting on the chassis 6 of vehicle 2, more particularly on the first mounting means 34 thereof, such as the flanges 34 positioned on or close to the sides of vehicle 2 and having the pivot shafts 43 mounted therein, the processing unit 3, in the shown embodiment the lower hemp picking element 25, is provided with second mounting means 32. The second mounting means 32 are embodied for easy mounting on first mounting means 34. The first and second mounting means 34, 32 together form a mounting hinge between processing unit 3 and vehicle 2, such that processing unit 3 can be pivoted in upward and downward direction around the lying pivot shafts 43 (pivoting direction R₁, FIG. 9).

To make processing unit 3 pivot relative to vehicle 2 the above-described lifting unit is utilized. As described above, the lifting cylinders 36 are arranged rotatably on the flanges 38a of chassis 6 at one outer end. On their opposite sides the lifting cylinders 36 are coupled via mounting supports 38b to the transverse lifting arm 47c. Transverse lifting arm 47c of the lifting unit has a substantially U-shaped cross-section, which is clearly visible particularly in FIGS. 1 and 3. The U-shape forms a receiving space for a part of the frame part 30 of the lower hemp picking element 25. In other words, the processing unit 3 can be connected to the lifting unit in simple manner by placing frame part 30 of lower hemp picking element 25 into the transverse lifting arm 47c of the lifting unit from above or, conversely, by simply pressing transverse lifting arm 47c against frame part 30 from below. Finally, the whole is locked by a locking mechanism 70 (FIG. 3), for instance in the form of a remotely controllable extending cylinder which in extended state ensures that processing unit 3 remains locked to the lifting unit. The lifting unit is then ready to lift processing unit 3.

As shown with arrows (P₁) in the figures, the length of lifting cylinders 36 is controllable. It will be apparent that when the length of lifting cylinders 36 is increased, frame part 30 will pivot upward, while frame part 30 will pivot downward if the length of lifting cylinders 36 is reduced. In this way the height of the free end of the processing unit can be varied, for instance in order to adjust the position in which the processing unit grips the fibre plants and pulls them from the ground during travel of the vehicle.

The mounting means of each of the different processing units 3 are essentially identical. This means that the different processing units can not only be easily mounted on and detached from the vehicle, but that this can also take place in a uniform manner. It is noted here that when processing units 3 are exchanged, only the mounting means of processing unit 3 (i.e. the second mounting means 32 when the processing unit is a picking unit for long fibre plants, third mounting means when the processing unit is a picking unit for short fibre plants and fourth mounting means when the processing unit is a turning unit for turning long or short fibre plants) need in fact be released from the first mounting means of the vehicle, after which processing unit 3, particularly the frame part 30 thereof, can be removed from the upper side of cylinder 36. By now simply pacing another processing unit 3 on the lifting unit of vehicle 2 and mounting the associated mounting means on the first mounting means of the vehicle, the user can easily make processing machine 1 suitable for the specific desired process, such as picking of short fibre plants, picking of long fibre plants or picking up and turning fibre plants.

As described above, FIGS. 4, 5, 8, 9A and 9B comprise an embodiment of a processing machine 1 according to the invention wherein the processing machine is provided with an exchangeable picking unit comprising a first picking element and a second picking element placed thereabove. The embodiment is embodied for picking of relatively long fibre plants, such as hemp plants, as shown schematically in the figure.

In the shown embodiment the processing machine 1 comprises the above stated self-propelling vehicle 2 and a specific processing unit 3, i.e. a hemp picking unit. The hemp picking unit comprises a lower hemp picking element 25 and arranged thereabove an upper hemp picking element 26. The lower picking element 25 is mounted on the first mounting means of the vehicle in the above stated manner, this such that the first hemp picking element 25 can be pivoted in upward and downward directions (pivoting directions R₁. FIG. 9A) by controlling said lifting cylinders 36 (FIGS. 9A and 9B). The upper hemp picking element 26 is pivotally arranged via pivot shafts 43 on the lower hemp picking element 25 so that the upper hemp picking element 26 can be pivoted (pivoting directions R₂) relative to the first hemp picking element 25 (and relative to vehicle 2 and the ground surface). The pivoting movement of the upper hemp picking element 26 relative to the lower hemp picking element 25 is driven by one or more further actuators, such as electric motors or lifting cylinders 42, arranged on frame parts 30, 33 (FIG. 9A). If the actuators comprise lifting cylinders 42, increasing the length of the lifting cylinders 42 results in an upward rotation of the upper hemp picking element 26 relative to the lower hemp picking element 25, while a reduction of the length results in a downward rotation of the upper hemp picking element 26 relative to the lower hemp picking element 25.

FIG. 4 shows schematically that the relatively long fibre plants (h), such as hemp, kenaf or similar fibre plants, have an overall length lₜₒₜ (characteristically between 1.4 and 4.0 metres, 2.4 metres on average). The lower part (h₁) of each of the fibre plants (h) has a length lₒ (for instance 110 cm to 120 cm), while the upper part (h₂) has a length l_{b} (for instance 120 to 130 cm). In the shown embodiment both lengths lₒ and l_{b} are roughly the same, although in practice these lengths may of course differ. What is important is only that the fibre plants (h) are cut into at least two parts (h₁, h₂) and then processed further by processing machine 1. Said lower hemp picking element 25 is for this purpose made suitable for picking and processing the lower fibre plant parts (h₁), while the upper hemp picking element 26 is intended for picking the upper fibre plant parts (h₂).

The upper hemp picking element 26 comprises a transport installation 46 for gripping hemp plants and transporting them to vehicle 2, while the lower hemp picking element 25 comprises a (preferably wholly or almost wholly identical) transport installation 45 whereby hemp plants can likewise be gripped and transported to vehicle 2. When vehicle 2 travels in a forward direction (P_{A,v}), the upper hemp picking element 26 will reach the hemp plants first. After a short time interval the lower hemp picking element 25 will also reach these same hemp plants. In other words, the engaging position at which the upper hemp picking element 26 engages a determined hemp plant at a determined point in time (which is determined in principle by the position at which the transport installation 46 of the upper hemp picking element 26 begins to grip a fibre plant (h)) is shifted relative to the engaging position at which the lower hemp picking element 25 engages a (different) fibre plant at the same point in time (i.e. the position at which the transport installation 45 of the lower hemp picking element 25 begins to grip the fibre plant (h)). This has the result that the upper hemp picking element 26 first engages the upper part (h₂) of the hemp plants and cuts them loose from the lower part (h₁) with a cutting unit 55 (also referred to here as mowing unit 55) provided on the front side of the upper hemp picking element 26, while it is after this, so only when upper part h₂ has been cut loose and is already being carried away, that the lower hemp picking element 25 will engage on the lower part (h₁) of the same hemp plant (h).

The lower hemp picking element 25 is configured to engage the lower part (h₁) of the hemp plant. As a result of the forward movement of vehicle 2 and/or as a result of displacement by means of the transport installation 45 to be described further below the hemp plants are pulled from the ground along with the roots. It is therefore noted that the lower part of a hemp plant is in principle not cut loose from the roots before the hemp plant has been pulled from the ground as a whole.

As shown in FIG. 4, the gripped upper part (h₂) of a hemp plant (h) which has been cut loose with mowing unit 55 is picked up by the upper hemp picking element 26. This upper part (h₂) of the fibre plant comprises a top, flower or plume portion (h₅) and a remaining upper portion (h₃). As will be elucidated below, in determined embodiments the top portion (h₅) of the upper part (h₂) of the hemp plant (h) (wherein this top portion (h₅) is also referred to as the Cannabidiol-containing (CBD-containing) portion) will be removed using a cutting unit. The top portion (h₅) is here discharged via discharge means comprising a discharge pipe 28 with an inlet opening close to the cutting unit, a centrifugal fan 20 connected to the discharge pipe and an outlet opening to a receptacle 16 arranged via a frame 17 on the rear side of vehicle 2. As shown in FIG. 4, this receptacle 16 is releasably mounted via rapid couplings 18 on a frame part of frame 6 and will essentially only be used when the intention is to remove the top portions (h₅) from a fibre plant. In other words, when the top portion is not cut off, receptacle 16 can optionally be dispensed with.

In the embodiment shown in FIG. 4 the discharge pipe 28 for discharging the top portions cut off by the cutting unit is positioned on the inlet side of the centrifugal fan 20. The centrifugal fan 20 is here arranged on the receptacle 16. In other embodiments, such as the embodiment of FIG. 16, a centrifugal fan 24 is however arranged on the lower hemp picking element 25 and the outlet side thereof is connected via a flexible tube 27 to a collecting mouth 29 for collecting the cut-off top portions. The centrifugal fan 24 hereby provides for (Venturi principle) an underpressure for collecting the cut-off top portions in the collecting mouth 29. Collected top portions are then blown to receptacle 16.

The lower part (h₁) of a hemp plant (h) is similarly composed of a root portion h₆ where the roots of the hemp plant are located and a remaining lower part h₄. In determined embodiments the root portion h₆ will be removed from the lower part h₁ of the hemp plants (h) by means of a root cutting unit to be further described below (for instance the root cutting unit of FIG. 14 to be described below). These removed root parts h₆ can be discharged to the receptacle 16 on the vehicle, although they are preferably dropped (in a manner which is not further described) directly onto the ground (o). In a determined embodiment the cutting unit and the associated discharge means of the root portions (h₆) are embodied such that these portions come to lie directly in front of one or more of the wheels 7, 8. This has the result that when vehicle 2 advances, the cut-off root portions h₆ are compressed or even pressed into the ground under the weight of the tyres of wheels 7, 8. In other words, in this embodiment the roots are pressed into the ground and the tops are collected in receptacle 16, which has the result that the delivering units 13 place only the lower remaining parts (h₄) and the upper remaining parts (h₃) of a hemp plant (h) onto the ground (o) on the rear side of the vehicle. As further elucidated elsewhere, in determined embodiments the two delivering units 13 are configured to place a first row 15a of only lower remaining parts (h₄) of the hemp plant and a second row 15b of only upper remaining parts (h₃) of the hemp plants (h) onto the ground and then have them undergo the desired retting process (FIG. 2).

FIG. 5 shows a view of hemp picking unit 3, while FIG. 7 shows a part of the upper picking element 26 of hemp picking unit 3 in more detail. Both figures show the transport installations 45, 46 whereby the hemp plants are gripped and transported to vehicle 2. Each of the transport installations 45, 46 comprises a number of endless belt conveyors, more particularly a first number of endless belt conveyors for gripping the crop, transporting it and tilting the crop during transport, and a second number of endless belt conveyors for receiving the crop from the first number of belt conveyors and transporting the crop to the conveyors on vehicle 2. The second number of conveyors (characteristically 3, 4 or more) is here usually smaller than the first number of conveyors (characteristically 1 or 2).

Guide elements 40 are provided on the front side of both the lower hemp picking element 25 and the upper hemp picking element 26. Their object is to make it possible to be able, when the vehicle and the picking unit 3 mounted thereon are advanced, to push the hemp plants (h) to the side and guide them into a number of, in FIG. 5 six per hemp picking unit (although this can also be a greater or smaller number in other embodiments), passages 41¹-41⁶ for the upper hemp picking element 26 and passages 41⁷-41¹² for the lower hemp picking element 25, all configured to receive and grip the hemp plants. These twelve passages are formed by a number of driven conveyor belts and a number of pulleys.

Referring to FIGS. 6 and 7 (showing an alternative embodiment having only two passages. The operation of the embodiment shown for instance in FIG. 5 is substantially the same), a first passage 41¹ is shown which is formed by the intermediate space between a first driven conveyor belt 90 and roller 92. A second passage 41² is formed by a second driven conveyor belt 91 and roller 93. Likewise, the third passage 41³ and fourth passage 41⁴ are formed by respectively conveyor belt 91′ and roller 93′, and conveyor belt 90′ and roller 92″.

When hemp plants (h, shown in FIG. 6 with black dots in as far as the hemp plants are in upright position and shown with broken lines as soon as the hemp plants have been rotated to the lying position) have found their way into the first passage 41¹ formed between the first driven conveyor belt 90 and roller 92, they are pulled along in the direction indicated by the arrow. Along the first section the hemp plants which have found their way into passage 41¹ are enclosed between the first conveyor belt and the roller 92 and transported thereby, further on the hemp plants come to lie between first conveyor belt 90 and second conveyor belt 91. The second conveyor belt 91 is a relatively short conveyor belt and extends in upward direction over its whole length. The second conveyor belt 91 is trained around said roller 93, a number of further rollers 94, 95 and 116 and a driven pulley or roller 96. The third conveyor belt 91′ of the third passage 41³ has essentially the same construction as the second conveyor belt 91, except in mirror image and driven by a drive pulley or drive roller 96′.

The first conveyor belt 90 is a lot longer than the second conveyor belt 91 and extends over a part of its length in upright state, but along a different part of its length the position of the conveyor belt is rotated from the upright position to a lying position, and further along from a lying position back to an upright position. The first conveyor belt 90 is trained around said roller 92 and a number of further rollers 113, 96 (via second conveyor belt 91), 102, 112, 115, 101, 97 (roller 97 is driven), 100, 99 and 98 (as seen in transport direction). The fourth conveyor belt 90′ of the fourth passage 41⁴ has essentially the same construction as first conveyor belt 90, except in mirror image and driven by a drive pulley or drive roller 97′ and trained over rollers 92′, 113″, 96′ (via third conveyor belt 91′), 102′, 112′, 115′, 101′, (driven) 97′, 100′, 99′ and 98′. The driven rollers or pulleys 97, 96, 96′ and 97″ (and in the embodiment of FIG. 5 the rollers or pulleys of the fifth and sixth conveyor belts 91″ and 90″ as well) are each driven individually by their own motor, preferably their own hydraulic motor 120 or electric motor (for instance a DC electric motor).

The figures show embodiments of the transport installations 45, 46 in which different endless belt conveyors are used for temporarily supplying a number of hemp plant streams. Parts of endless belt conveyors are here preferably used in combination in order to thus achieve an efficient use of the space available on the picking elements and/or to limit the complexity and thereby the costs of the transport installations. It is for instance shown in the drawings that a converging area 117 (FIG. 6), wherein two (or more) streams of hemp plants converge, is defined roughly halfway between the entry of the hemp plants on the front side of each of the transport installations 45, 46 and the delivery of the plants on the rear side of transport installations 45, 46 to vehicle 2.

Referring to FIGS. 6 and 7, which show an example of an upper hemp picking element 26, transport installation 45, 46 grip in each case the upper parts (h₂) of the hemp plants (h) via each of the passages 41 and process them further. The upper parts (h₂) of the hemp plants are pulled inward into said passages. In the drawings a small number of fibre plants (h) is shown with black dots, although in practice this number will of course be much greater and a substantially continuous row of fibre plants will be transported between the endless conveyor belts 90, 91 and 90′, 91′. As stated above, the cut-off fibre plants (h₂) extend in upward (vertical) direction in the first part of each of the passages, and further along in transport installation 45, 46 the cut-off hemp plants (h₂) are rotated through a quarter turn to a lying (substantially horizontal) position (fibre plant parts h₂ then being shown in broken lines). Once in this lying position, the fibre plants are transferred from an endless belt conveyor to a further endless belt conveyor (i.e. conveyor 50 of the upper hemp picking element 26 and conveyor 51 of the lower hemp picking element 25).

Referring to FIG. 8, each of the conveyors 50, 51 is constructed in known manner from two mutually adjacent endless conveyor belts which run on rollers in likewise known manner and are advanced via a drive (not shown). The hemp plant parts (h₂) are transported further toward vehicle 2 by carriers 56 provided on the endless conveyor belt of conveyor 51, 52 (FIG. 8). Carriers 56 ensure that no hemp plants remain behind and that carried along hemp plants come to lie neatly parallel to each other, perpendicularly of the longitudinal direction (i.e. the axial direction) of machine 1.

FIGS. 5-7 show the operation of transport installation 45 and particularly the turning over of the hemp plants in more detail. The two streams of hemp plants which enter via passages 41¹ and 41² converge between conveyor belts 90 and 91. The hemp plants (h₂) are then transported on between conveyor belts 90, 91 and, after having passed the driven pulley or roller 96, reach said collecting area 117. In the embodiment of FIGS. 6 and 7 the streams from passages 41¹/41² and 41³/41⁴ converge in this collecting area 117. FIG. 5 shows an embodiment where the combined streams of passages 41¹ and 41² on one side and the combined streams of a number of other passages on the other converge in collecting area 117. In the embodiment shown in FIG. 6 these are passages 41³ and 41⁴, but in the embodiment of FIG. 7 they are the streams from passages 41³, 41⁴, 41⁵ and 41⁶ which in turn have already converged previously in a collecting area 117.

As shown particularly in FIG. 7 (but also in FIGS. 5 and 6), both conveyor belt 90 of the first and second passages 41¹ and 41² and the conveyor belt 90′ of the third and fourth passages 41³-41⁴ (or third to sixth passages in the embodiment of FIG. 5) are tilted after passing both rollers 102, 102′ in that the respective belts 90, 90′ are guided over rollers 112 having a rotation axis which lies perpendicularly of the rotation axis of rollers 102, 102″.

As shown on the right-hand side of FIG. 7, the hemp plants (i.e. the upper parts h₂ cut off by mowing unit 55, so consisting of the top parts h₅ which have not yet been cut off at that point and the remaining upper parts h₃) will be supplied and transported between the conveyor belts in upright position. At a certain point their position changes in that they come to lie between conveyor belts 90 and 90′. At the position of horizontal rollers 112, 112′ the hemp plants are released and are received by the further conveyor 50 and transported on. This is shown in more detail in FIG. 8.

The horizontally oriented hemp plant parts (h₂=h₃+h₅) reaches the endless belt conveyor 50. The cut-off hemp plants (h₂) are enclosed between the underside of the endless belt conveyor 50 and the upper side of a number of upright guide flanges 150 on frame part 33 and transported toward vehicle 2. During this transport the hemp plants (h₂) are processed by pressing (rolling) them and by cutting the top portions (h₅) off the pressed hemp plants (h₂) and discharging them.

The lying hemp plants (h₂) are first guided between an upper pressing roller 136 and lower pressing roller 137 so that at least the relevant tops (h₅) (these often taking the form of a plume) are pressed. These pressed top portions (h₅) of the hemp plants (h₂) are then cut off via a top cutting unit 38. This top cutting unit 38 is represented in highly schematic manner in FIG. 8 as a vertically arranged rotatable circular knife. The housing around this circular knife 38, the drive of the rotation of circular knife 38 and guide means for displacing circular knife 38 in lateral direction P_{L} are not shown. The lateral displacement of the cutting unit is driven by a hydraulic or electric actuator, for instance a hydraulic motor or an electric motor. The cut-off top portions or top parts (h₅) of the hemp parts are extracted via the extraction means 29, for instance a collecting mouth 29, connected to an extraction pipe 28 and a centrifugal fan 20, and blown into the receptacle 16 on the rear side of vehicle 2 for storing the top parts therein.

The picking and further processing of the upper parts (h₂) by means of the upper picking unit 26 is described in detail with reference to FIGS. 5-8. The lower parts (h₁) of the hemp plants (h) are similarly picked and further processed by the lower hemp picking element 25. A detailed description of the way in which these lower parts (h₁) of the hemp plants are gripped and processed can therefore be dispensed with. The lower hemp parts (h₁) are gripped and carried along in similar manner by a transport installation 45, rotated through a half turn until they are in horizontal position and then discharged by a conveyor 51.

FIG. 9A otherwise shows a situation in which the lower hemp picking element 25 is in the lowest pivot position. In other words, lifting cylinder 36 is in the wholly retracted state. FIG. 9B, which shows only the lower hemp picking element 25 and wherein the upper hemp picking element 26 is not shown for the sake of convenience, shows a situation in which the lower hemp picking element 25 is pivoted upward to some extent. In other words, lifting cylinder 36 has become longer. In this way the pivot position of the lower hemp picking element 25 can be set as desired, for instance depending on the soil condition (if the soil is level the hemp picking element 25 can be placed closer to the soil/ground than if the soil is uneven). Similarly, the position of the upper hemp picking element 26 can be set as desired with lifting cylinders 42. In the shown embodiment the position of the upper hemp picking element 26 can be set essentially independently of the position of the lower hemp picking element 25. The pivot position of the upper hemp picking element 26, and thereby the height at which the front part of guides 40 and/or the mowing unit extend above the ground, can be set depending on the height of the crop to be harvested. In the case of relatively high hemp plants (for instance more than 3 m long) the upper hemp picking element 26 will generally be pivoted further upward, while the hemp picking element 26 is placed further downward in the case of shorter hemp plants (<3 m). It is important here that the crop is cut at a correct height (i.e. height lₒ in FIG. 4) in order to realize an upper part (h₂) and a lower part (h₁) of the crop with different dimensions. It is noted here that the pivot position of the processing unit, more particularly the pivot position of at least one of the upper and lower picking element, can be adjusted continuously (optionally during travel) in order to ensure that, if there are height variations in the ground surface and/or height variations in the fibre plants, these can be followed so that there is essentially no effect on the swathe.

In the above stated embodiments the processing machine 1 is geared toward processing relatively high/long crops, such as hemp. In other embodiments processing machine 1 can be made suitable in very simple manner for processing shorter/less high crops, such as flax. For this purpose hemp picking unit 3 consisting of at least the upper and lower hemp picking elements 25, 26 is replaced with a flax picking element 129 which is embodied specifically to process this lower crop. The height of the crop, such as flax, is usually between 80 cm and 120 cm (lₜₒₜ=80-120 cm).

As shown in FIGS. 11 and 12, the flax picking element 129 comprises a chassis frame part 130 which is provided with essentially the same mounting means as the above stated lower hemp picking element 25 of the hemp picking unit. Frame part 130 can for instance be mounted on the pivot shaft of the first mounting means 34 of vehicle 2 in simple manner with said mounting means 32. This flax picking unit can be placed on the transverse lifting arm 47c of the lifting unit of vehicle 2 in manner similar as the hemp picking unit so that lifting cylinders 36 can pivot frame 130 of the flax picking element in upward and downward direction. The present flax picking unit essentially uses the same techniques to grip this fibre plant, in this case flax, pull it from the ground and transport it toward vehicle 2, and to change the position of the crop during transport toward vehicle 2. Use is for this purpose once again made of a transport installation which is once again constructed from the above-described endless belt conveyors, among other things. A difference with the hemp picking unit is however that the flax picking unit provides the option and space to realize a plurality of passages adjacently of each other. While there are six passages per hemp picking element (so a total of twelve passages, although this number can also be increased or reduced in other embodiments) in the hemp picking unit, there are eight passages in the embodiment of FIGS. 10 and 11, these all being positioned adjacently of each other. The four passages on the left receive flax and this flax is carried via a first conveyor 150 to the first conveyor 11 on vehicle 2, while the four passages on the right are used to carry the remaining flax plants via a second conveyor 151 toward the second conveyor 12 of vehicle 2. The two conveyors 150, 151 are here situated adjacently of each other instead of above each other, as was the case in the hemp picking unit.

FIG. 11 further shows that the flax, at least the upper part thereof, is once again pressed by two pressing rollers 136, 137 in determined embodiments. In determined embodiments the top parts (particularly the bolls, seed capsules) are once again cut off, whereas in other embodiments the cutting off does not take place. These pressing rollers 136, 137 and/or this cutting unit are otherwise also optional, and in determined embodiments they are therefore dispensed with.

FIGS. 4-9B show embodiments of picking units for picking relatively long fibre plants, such as the hemp picking unit, and FIGS. 10-11 show picking units for picking relatively short fibre plants, such as the flax plant picking unit of FIGS. 10 and 11. These are however merely specific examples of processing units which can be mounted on vehicle 2 and removed from vehicle 2 in the above stated simple manner. Another example of such a processing unit is a pick-up unit. As already described above, the fibre plants are placed down flat on the ground on the rear side of the vehicle after having been picked and rotated. These fibre plants are then left on the ground for some time so that a retting process takes place. To enable retting to take place properly and uniformly, the fibre plants on the ground surface must however be turned over at regular intervals. This turning over can likewise be performed with the same processing machine 1, wherein a so-called pick-up unit is then however arranged as processing unit 3. The previously used picking unit, for instance flax picking unit or hemp picking unit, is exchanged for a pick-up unit which is configured to pick up the crop lying flat on the ground, rotate it through 180° and place it back onto the ground in overturned state on the rear side of the vehicle. This turning over of these picked-up fibre plants can once again take place in similar manner using endless conveyor belts between which the fibre plants are gripped. Conveyor belts are here placed such that the fibre plants are rotated through a half turn instead of a quarter turn. The fibre plants reach the vehicle in the overturned (half turn) state and can be transported toward the delivering units in known manner by the vehicle. This application requires in principle no modifications on vehicle 2 either to make it suitable for picking up and turning the fibre plants. This means that the processing machine is not only suitable for picking fibre plants of different lengths (i.e. relatively long fibre plants such as hemp or relatively short fibre plants such as flax), but is also suitable for picking back up, wholly turning over and placing back onto the ground surface fibre plants after they have been picked and placed down on the ground. In other words, the proposed processing machine is not only a picking machine but also a turning machine. It will be apparent that the costs of processing the fibre plants can hereby be limited to considerable extent and an extremely versatile processing machine can be realized.

FIG. 13 shows a further embodiment of a processing unit 113 for picking relatively long fibre plants, such as hemp. Processing unit 113 has a pivotable upper picking element 123 and a pivotable lower picking element 125. The lower picking element 125 comprises a frame 140 and the upper picking element 123 has a frame 148. The frame 140 of the lower picking element 125 has a first frame part 140a which can be mounted pivotally on vehicle chassis 6 in the known, above described manner using the third mounting means 32a. This first frame part 140a can be pivoted in upward and downward direction using the above described lifting unit comprising a number of lifting cylinders 36. Formed integrally on frame part 140a is a second frame part 140b. Second frame part 140b lies here at an angle (characteristically of about 45 degrees) relative to first frame part 140a. A third frame part 140c is further formed between the first and second frame parts 140a, 140b. This third frame part 140c functions as support for the first and second frame parts and ensures that the two frame parts keep extending at said angle under heavy load as well. Second frame part 140b further comprises a number of support flanges 141 on which a number of lifting cylinders 142 are mounted. Lifting cylinders 142 are pivotally coupled with their outer ends via respective hinges 144 and 145 to the second frame part 140b of the frame 140 of lower picking element 125 and to the frame 148 of upper picking element 123. By increasing or reducing the length of lifting cylinders 142 (see arrows) the upper picking element 123 can be pivoted respectively upward and downward.

FIG. 13 also shows an embodiment of the above stated root cutting unit 160 and the cutting unit or mowing unit 55 on the front side of the upper picking element 123. The root cutting unit 160 shown in FIG. 13 is shown in more detail in FIG. 14. The root cutting unit 160 is positioned on the underside of lower picking element 125 in order to cut the root portions (h6) off the flax plants (h) pulled from the ground and transported therealong by the endless belt conveyor 90. Root cutting unit 160 comprises two supports 160, 160′, mutually connected with a support arm 166, wherein a lying (horizontal) cutting part 164 is arranged between the two supports 160, 160′. Cutting part 164 is provided with two circular knives 168, 168′ which can be rotated via respective root cutting unit drive motors 169, 169′. In this embodiment the root portions cut off by the rotating circular knives 168, 168′ drop directly downward and end up on the ground. In other embodiments (not shown) a provision is also made to have the cut-off root portions drop to the ground at a specific lateral position, for instance at one or more lateral positions directly in front of at least one of the two front wheels 7. It is further shown that the height of cutting part 164 relative to the rest of the first picking element can be adjusted by controlling an actuator 165, for instance an electric motor or a hydraulic and/or electric lifting cylinder, which drives the rod system 167 on which the cutting part 164 is mounted. A single actuator can be provided, for instance mounted on support 160 or support 160′, although in other embodiments an actuator is provided at both outer ends of cutting part 164. The rods of rod system 167 are mounted rotatably on the support 160, 160′, this such that by pushing against or pulling on the upright rod of the rod system the rods are set into rotation and in this way move cutting part 164 respectively upward and downward.

FIG. 13, and in more detail FIG. 15, also show the cutting or mowing unit 55 already described above with reference to FIG. 4. The cutting unit 55 in FIG. 4 was mounted on the underside of the frame 33 of the upper picking element 26, while the cutting unit of FIG. 15 is arranged on the underside of frame part 148 of the upper picking element 123. The embodiment and operation of cutting unit 55 is however the same in both embodiments.

Cutting unit 55 comprises two support cheeks 57, 57 provided on the underside of frame part 148. Respective L-shaped supports 61, 61′ are mounted rotatably (via rotation shafts 58) on the two support cheeks 57, 57′. The rotation movement of the two L-shaped supports is realized by an actuator 59, for instance an actuator 58, such as an electric motor, mounted on the relevant support cheek 57, 57′. Rotation of the L-shaped supports 61, 61′ provides for upward or downward movement of an elongate cutting unit. The height of the cutting unit relative to the rest of the picking element and thereby the height of the cutting unit relative to the ground surface can hereby be adjusted as desired.

The actuator is preferably remotely controllable, for instance from the driver's cab 23 (FIG. 4), so that the height of the cutting unit relative to the rest of the picking element can be adjusted remotely, for instance during travel of the vehicle or just before a quantity of fibre plants of a determined length will be picked. In determined embodiments the actuator 58 is adjusted automatically. For this purpose the actuator 58 is connected to the control unit 44, wherein the control unit is configured to control the actuator depending on, among other things, the height of the fibre plants observed by the camera unit of the system.

In the shown embodiments the cutting unit is constructed from a (horizontal) row of mutually reciprocally displaceable blades 60 in which a large amount of fibre plants can be cut, this row extending over a substantial or substantially whole width of the upper picking element. The reciprocal displacement of the blades of such a cutting unit is driven by a motor 61, for instance an electric or hydraulic motor and a suitable transmission mechanism.

Because the processing machine is in determined embodiments of the invention able to adjust the position/orientation of the processing unit 3 (more particularly adjust the pivot position of the flax picking element of the flax picking unit, the pivot positions of both the upper picking element and the lower picking element of the hemp picking unit, the pivot position of the pick-up unit, the height of cutting unit/mowing unit 55, the position (height) of root cutting unit 160 and/or the (lateral) position of top cutting unit 38) and because this position adjustment (in height direction and lateral direction) further preferably takes place during travel and processing of the fibre plants, it is possible to optimally anticipate the local conditions in the field, for instance a varying height of the fibre plants, a varying orientation of the ground surface, and the like. This varying of the height and/or lateral cutting position can be controlled manually via suitable operating elements in driver's cab 23. In further embodiments this is however done by means of an electronic control unit 44 (shown schematically in FIG. 16), for instance a microcontroller or computer. This can be connected to one or more sensors, such as one or more optical detectors of the camera unit, whereby the height (and/or other parameters) of the fibre plants can for instance be measured. The electronic control unit 44 can then (before or during processing of the fibre plants, so while travelling) control one or more of the processing unit (i.e. one or more of the flax picking element, upper picking element, lower picking element and pick-up unit), the root cutting unit, the top cutting unit and the mowing unit on the basis of the measurement signals of the one or more sensors and on the basis of a predetermined control algorithm. The adjusting can take place dynamically, which means that the control is performed continuously or periodically with a short time interval, so as to thus always have the processing machine in an optimal position during travel. An additional advantage is that, even when the height of the fibre plants varies, the control unit 44 controls at least one of the flax picking element, the upper picking element, the lower picking element, the pick-up unit, the root cutting unit, the top cutting unit and/or the mowing unit such that the swathes on the rear side of the vehicle are formed neatly aligned and at respective desired lateral positions behind the vehicle. The control unit can be set here to have the fibre plants in each swathe be positioned on the ground surface such that the centres of each of the plants in the relevant swathe extend substantially along an imaginary (straight) centre line behind the vehicle. The control unit can further be set such that the imaginary centre line of the swathes extend symmetrically round an imaginary (axial) centre line of the vehicle. It is however also possible to shift the imaginary centre lines of the swathes to some extent relative to the centre line of the rear side of the vehicle.

Embodiments wherein the cutting positions of the cutting units (i.e. the top cutting unit 38, the cutting or mowing unit 55 and the root cutting unit 60) are adjusted depending on the height of the crop to be processed are discussed below with reference to FIGS. 16-18.

FIG. 16 shows that a camera unit 170 with one or more cameras is arranged on top of driver's cab 23. The camera unit 170 is connected to a central control unit 44 and is configured to generate image signals and send them to the control unit. These image signals are representative of the forward view and are used by the control unit to determine the height (lₜₒₜ) of the fibre plants to be processed. Depending on the height of these fibre plants, the driver and/or the central control unit can then set a desired height position of at least one (and preferably each) of the first picking element 25, second picking element 26, the top cutting unit 38, the cutting or mowing unit 55 and the root cutting unit 60 for the purpose of cutting the fibre plants into pieces in optimal manner and/or laying the picked fibre plants in swathes in optimal manner. It can be the case here that, just before the picking of the fibre plants is started, the (average) length (lₜₒₜ) of the fibre plants is determined and that the different (height and/or lateral) positions of the cutting units are set once. This setting then remains in principle unchanged during the picking. In other embodiments the settings of the height positions are adjusted during the picking, i.e. during travel, so that any variations in the length of the fibre plants (or the length of determined important parts thereof, for instance the top portions) can for instance be followed.

To adjust the positions of the picking elements and cutting units use can in determined embodiments be made of predetermined drive algorithms whereby the picking can take place in optimal manner. These drive algorithms can for instance be stored on the control unit. The control unit for instance periodically determines the desired positions of the picking elements and cutting units. When one or more of the determined positions changes, the control unit generates one or more control signals and sends them to relevant picking elements and cutting units, so that the lifting units and actuators provided therein can ensure that the correct position of the picking elements and cutting units is automatically reached.

FIG. 17 shows an example of such a control for a vehicle 2 travelling over a field (ground surface O). The figure shows a diagram with the height relative to the ground surface (O) along the vertical axis and the time along the horizontal axis. The figure shows the current measured height of the fibre plants with the full line 71. It is noted here that the measured height is in fact the current measured height (length) of the fibre plant (h) above the ground surface. In other words, the measured length is the length (lₜₒₜ) of the whole fibre plant (h) minus the length of the root portion (h₆), see FIG. 4. The engaging positions of the upper picking element 26 and of the lower picking element 25 (in other words, the front positions of the transport installations 46 and 45 whereby the upper and lower picking elements 26 and 25 grip a hemp plant) over time are shown respectively with broken lines 72 and 73, while the cutting positions over time of the top cutting unit 38 are shown with dot-dash line 74 (wherein the shown cutting position indicates the height position corresponding with the lateral position of the top cutting unit 38, more particularly the knife thereof, since the top portions (h₅) are not cut off until the relevant fibre plant part has rotated from an upright position to a lying position), the cutting positions over time of the cutting or mowing unit 55 with dot-dash line 75, and the cutting positions over time of the root cutting unit 160 with the full line 76.

A starting point for the algorithm can be that the length (l_{b}) of the cut-off upper part (h₂) of the fibre plants (h) must in principle be roughly the same as the length (lₒ) of the cut-off lower part (h₁) of the fibre plants (h), that the upper part and the lower part may each have a predetermined maximum length (lₘₐₓ) (this length corresponding to the width of the relevant swathe 15a, 15b, FIG. 3), and that the top portion (h₅) (this forming part of the upper part (h₂)) must always have a determined length (lₘᵢₙ).

If for instance the maximum length (lₘₐₓ) of each of the upper and lower part of the fibre plant is 1.0 m and the minimum length (lₘᵢₙ) of the top portion (h₅) amounts to 0.2 m, the picking elements and cutting units will at a measured height of the fibre plant of 2.4 m (in the time interval 77, FIG. 17) be set such that the upper part (h₂) and the lower part (h₁) of the fibre plants is 1 m (and the two swathes 1 thus each become 1 m wide) and that the cut-off top portion is 0.4 m. When the length of the fibre plants decreases to 2.2 m (in time interval 78 in FIG. 17), the position of at least one of the picking elements and cutting units is set such that the upper part (h₂) and the lower part (h₁) of the fibre plants remains 1.0 m (and the two swathes thus each remain 1.0 m wide) and that the cut-off top portion is 0.2 m long. When the length of the fibre plants however decreases to 2.0 m (in time interval 79 in FIG. 17), the position of at least one of the picking elements and cutting units is set such that the upper part (h₂) and the lower part (h₁) of the fibre plants is 0.9 m (and the two swathes thus each become 0.9 m wide) and that the cut-off top portion is 0.2 m long. When the length of the fibre plants then increases again, for instance to 2.6 m (in the time interval 80 of FIG. 17), the position of at least one of the picking elements and cutting units is set such that the upper part (h₂) and the lower part (h₁) of the fibre plants is once again 1 m (and the two swathes 15a, 15b thus each become 1 m wide) and that the cut-off top portion is 0.6 m long.

Similarly to FIG. 2, FIG. 18 shows a top view of the swathes realized by the processing machine if the height of the fibre plants varies as shown in FIG. 17. The swathes 15a and 15b are in principle the same in time intervals 77, 78 and 80, while in time interval 79 the width of each of the swathes 15a and 15b decreases, while the imaginary centre lines 88, 89 through each of the swathes 15a, 15b in principle remains the same over all time intervals. A maximal quantity of usable fibre plant parts can hereby be harvested without the swathes provided behind the vehicle being shifted.

The present invention is not limited to the embodiments described herein. The rights sought are defined by the following claims, within the scope of which numerous modifications can be envisaged.

1. A processing machine configured to process fiber plants, the processing machine comprising:
a self-propelling vehicle comprising
a vehicle chassis with, disposed thereon, at least three wheels and a drive motor configured to drive at least two of the wheels, the vehicle chassis being provided with:
a first conveyor configured to transport at least parts of the fiber plants from a first end to an opposite second end, and a second conveyor configured to transport at least parts of the fiber plants from the first end to the second end,
first and second delivering devices provided at or close to the second end to deliver and place the fiber plants respectively coming from the first and second conveyors on a ground surface,
a picking system configured to pick the fiber plants and process the fiber plants further, the picking system comprising a lower picking element and an upper picking element configured to respectively pick a lower part of the fiber plants and an upper part of the fiber plants, the upper picking element being configured to pivot relative to the lower picking element,
a displaceable top cutter configured to cut top parts off the fiber plants at a specific length,
one or more lifting systems configured to pivot the lower and upper picking elements relative to each other and relative to the vehicle chassis, and
an electronic controller configured to determine a height value representative of a height of the fiber plants, the electronic controller being configured to determine specific positions of the pivotable lower picking element and the pivotable upper picking element, based on the determined height value of the fiber plants.

2. The processing machine according to claim 1, wherein the electronic controller is configured both to control the one or more lifting systems of the lower picking element and to control the one or more lifting systems of the upper picking elements to pivot the lower picking element and the upper picking element to the respective determined specific positions independently of each other.

3. The processing machine according to claim 1, wherein the electronic controller is configured to determine a particular position of the top cutter and to control at least one actuator whereby the top cutter is displaceable to the determined particular position relative to one or more of the lower picking element and the upper picking element, based on the determined height value of the fiber plants,
wherein the at least one actuator is configured to displace the top cutter to the determined particular position independently of displacement of the lower picking element and the upper picking element.

4. The processing machine according to claim 1, further comprising at least one of a displaceable root cutter configured to cut roots off the fiber plants at a specific length and a displaceable fiber plant cutter configured to cut fiber plants, the electronic controller being configured to determine the specific positions of one or more of the displaceable root cutter and the the displaceable fiber plant cutter, based on the determined height value of the fiber plants.

5. The processing machine according to claim 4, wherein the electronic controller is configured to control a first actuator of the top cutter, a second actuator of the root cutter, and a third actuator of the displaceable fiber plant cutter, based on the determined specific positions, to respectively displace the top cutter, the root cutter, and the and the displaceable fiber plant cutter to the respective specific positions, the electronic controller being configured to respectively displace the top cutter, the root cutter, and the displaceable fiber plant cutter to the respective specific positions independently of each other and independently of displacement of the upper and lower picking elements.

6. The processing machine according to claim 1, further comprising an input device coupled to the electronic controller and configured to allow manual input of the height value and to transmit an input height value to the electronic controller.

7. The processing machine according to claim 1, further comprising:
a camera system with at least one camera, the camera system being configured to record images of the fiber plants to be processed and to generate an image signal which is representative of the recorded images,
wherein the electronic controller is coupled to the camera system and the camera system is configured to determine the height value of the fiber plants based on the image signal.

8. The processing machine according to claim 4, wherein the electronic controller is configured to control at least one of a first actuator of the top cutter, a second actuator of the root cutter, a third actuator of displaceable fiber plant cutter, and one or more lifting systems configured to make the first picking element and the second picking element pivot, based on the determined specific positions.

9. The processing machine according to claim 1, further comprising a first lifting system and a second lifting system configured to individually respectively pivot the lower picking element and the upper picking element.

10. The processing machine according to claim 9, wherein the second lifting system is disposed between the lower and upper picking elements and configured to pivot the upper picking element relative to the lower picking element.

11. The processing machine according to claim 1, wherein the upper pivotable picking element is pivotally disposed on the lower pivotable picking element.

12. The processing machine according to claim 1, wherein both the upper picking element and the lower picking element are couplable to the vehicle chassis via hinges.

13. The processing machine according to claim 1, further comprising a cutting system configured to cut the fiber plants in the lower part and the upper part, the cutting system being mounted on the upper picking element.

14. The processing machine according to claim 13, wherein the cutting system is disposed via a displaceable support on the upper picking element, the displaceable support comprising an actuator coupled to the electronic controller configured to cause the electronic controller to adjust the height of the cutting system relative to the rest of the upper picking element.

15. The processing machine according to claim 1, further comprising a transport installation configured to grip the fiber plants and transport the fiber plants to the first and second conveyors of the vehicle.

16. The processing machine according to claim 15, wherein the transport installation is configured to rotate the fiber plants during transport.

17. The processing machine according to claim 16, wherein one or more of:
(i) the transport installation of the upper and lower picking elements is configured to turn the fiber plants from a substantially upright position to a substantially lying position, and
(ii) the transport installation of the picking system is configured to turn the fiber plants from a substantially lying position to an overturned, substantially lying position.

18. The processing machine according to claim 15, wherein the transport installation is disposed on at least one of the lower picking element, the upper picking element, and the picking system.

19. The processing machine according to claim 15, wherein one or more of:
(i) the transport installation comprises at least one pair of endless conveyor belts which are configured to grip the fiber plants therebetween and to transport the fiber plants in a gripped state, a drive of the conveyor belts comprising one or more rollers driven directly via one or more hydraulic motors,
(ii) each of the picking elements of the picking system or the picking system has its own transport installation, one of the picking elements four pairs of the endless conveyor belts to grip and transport the fiber plants at four laterally mutually adjacent positions, and
(iii) both the upper and the lower picking elements comprise two pairs of endless conveyor belts to grip and transport the fiber plants in each case at two positions for each of the two heights.

20. The processing machine according to claim 1, wherein the upper picking element comprises an upper transport installation configured to grip and transport the upper part of the fiber plant to the first conveyor of the vehicle and the lower picking element comprises a lower transport installation configured to grip and transport the upper part of the fiber plant to the second conveyor of the vehicle.

21. The processing machine according to claim 4, wherein at least one of the root cutter and the top cutter is configured for lateral displacement on a frame of the picking system, the processing machine further comprising at least one actuator configured to set a lateral cutting position of parts of the fiber plants to be respectively transported to the first and second conveyors on the vehicle by displacing the respective cutters in a lateral direction.

22. The processing machine according to claim 4, wherein the electronic controller is configured to periodically repeat determining the height value of the fiber plants and determining the specific positions, and to periodically control at least one of the picking elements, the top cutter, the root cutter, and the displaceable fiber plant cutter, during travel of the vehicle.

23. The processing machine according to claim 1, further comprising a collector configured to collect and store therein cut-off parts of picked fiber plants including root parts and top parts of fiber plants.

24. The processing machine according claim 4, further comprising one or more of:
(i) a first discharge system configured to discharge the cut-off top parts from the top cutter to a collector on the self-propelling vehicle, the first discharge system comprising a discharge conduit and a suction pump that is a centrifugal fan, to collect and displace the cut-off top parts, and
(ii) a second discharge system configured to discharge cut-off root parts from the root cutter to the ground surface, the second discharge system being configured to deposit on the ground in front of one or more wheels of the vehicle in an axial direction.

25. A method of processing fiber plants using the processing machine according to claim 1, the method comprising:
driving the processing machine over the ground surface and picking the fiber plants while driving the processing machine, and then processing the fiber plants and thereafter placing the processed fiber plants back onto the ground;
determining the height value representative of the height of the fiber plants to be picked by the electronic controller; and
determining the specific positions of the pivotable lower picking element, the pivotable upper picking element, and the displaceable top cutter, based on the determined height value.

26. The method according to claim 25, further comprising controlling both the one or more lifting systems of the lower picking element and the one or more lifting systems of the upper picking elements to pivot the lower picking element and the upper picking element to the respective determined specific positions independently of each other.

27. The method according to claim 25, further comprising:
determining a specific position of the top cutter based on the determined height value of the fiber plants;
controlling at least one actuator such that the top cutter is displaceable to the determined specific position relative to one or more of the lower picking element and the upper picking element; and
displacing the top cutter to the determined specific position independently of displacement of the lower picking element and the upper picking element.

28. The method according to claim 25, further comprising:
determining the specific positions of at least one of the displaceable top cutter, a displaceable root cutter configured to cut roots off the fiber plants at a suitable length, and a displaceable fiber plant cutter configured to cut the fiber plants, based on the determined height value of the fiber plants; and
displacing the fiber plants to the determined specific positions, independently of each other and independently of displacement of the lower and upper picking elements.

29. The method according to claim 25, further comprising controlling at least one of a first actuator of the top cutter, a second actuator of a root cutter, and a third actuator of a fiber plant cutter configured to cut the fiber plants.

30. The method according to claim 25, further comprising receiving the height value by the electronic controller via an input device coupled thereto.

31. The method according to claim 25, further comprising:
recording images of the fiber plants to be processed with a camera system with at least one camera and generating an image signal which is representative of the recorded images; and
determining the height value of the fiber plants by the electronic controller coupled to the camera system, based on the image signal.

32. The method according to claim 25, further comprising respectively individually pivoting the lower and upper picking elements to achieve the specific positions for the lower and upper picking elements.

33. The method according to claim 25, further comprising:
gripping the upper parts of the fiber plants with the upper picking element;
cutting the gripped upper parts of the fiber plants loose with the top cutter;
transporting the upper parts of the fiber plants which have been cut loose to the first conveyor of the vehicle;
gripping lower parts of the fiber plants with the lower picking element;
transporting the gripped lower parts of the fiber plants to the second conveyor of the vehicle;
transporting the upper and lower parts of the fiber plants respectively on the first and second conveyors;
placing the upper parts of the fiber plants on the ground in a first row with the first delivering system; and
placing the lower parts of the fiber plants on the ground in a second row, parallel to the first row, with the second delivering system, and optionally pivoting one or more of the lower picking element and the upper picking element relative to the vehicle, and pivoting the top cutter relative to the upper picking element to set a length of the lower parts and a length of the upper parts of the fiber plants, based on the specific positions determined by the electronic controller.

34. The method according to claim 25, further comprising one or more of: (i) cutting top parts off the upper parts which have been cut loose, and (ii) cutting root parts off the lower parts of the fiber plants at the respective specific positions.

35. The method according to claim 25, further comprising periodically repeating the determining the height value which is representative of the height of the fiber plants which are about to be processed.

36. The method according to claim 25, further comprising, during travel, periodically repeating the determining based on an image signal of the height value of the fiber plants which are about to be processed.
